(19) United States
(12) Patent Application Publication
(10) Pub. No.: US 2011/0060737 A1
(43) Pub. Date: Mar. 10, 2011

(54) System for Matching Procedure Characteristics to Professional Experience

(76) Inventor: Jonathan Cardella, San Francisco, CA (US)

(21) Appl. No.: 12/849,739

(22) Filed: Aug. 3, 2010

Related U.S. Application Data
(60) Provisional application No. 61/230,979, filed on Aug. 3, 2009.
(60) Provisional application No. 61/231,315, filed on Aug. 4, 2009.
(60) Provisional application No. 61/230,981, filed on Aug. 3, 2009.

(51) Int. Cl. G06F 17/30; G06F 15/16

(52) U.S. Cl. 707/732; 709/203; 707/780; 707/E17.014; 707/E17.043

(57) ABSTRACT

A web service system dynamically matches professional experience with procedure characteristics submitted by a client through evaluating a professional's history of procedure outcomes in light of the requested procedure characteristics.

### RELATED APPLICATIONS

The present invention claims priority to U.S. Provisional Patent Application Ser. No. 61/230,979, filed on Aug. 3, 2009, U.S. Provisional Patent Application Ser. No. 61/231,315 filed on Aug. 4, 2009, and U.S. Provisional Patent Application Ser. No. 61/230,981 filed on Aug. 3, 2009, each of which is hereby incorporated by reference in its entirety.

### THE FIELD OF THE INVENTION

The present invention relates to searches for and directories of professional services. More specifically, the present invention relates to a system and method for matching procedure characteristics or other client characteristics with relevant professionals.

### BACKGROUND

Choosing a professional—such as a doctor, lawyer or mechanic—can be a daunting task. Currently professionals are found through personal recommendations, associations with insurance, advertising, internet searches and business networks. While each of these methods shows capability in reaching the professional's general target audience of clients and clients, the success in reaching the audience may not correlate well with recognized success in performing a procedure or providing a service.

Attempts have been made to remedy this information gap. Some websites aggregate professional profiles and associate the listings with a specialty. Other websites assign a static rating, showing whether the professional is overall a “good” professional or “bad” professional. These overall ratings are then used to recommend professionals to clients. Thus, the websites suggest that a professional who is highly ranked overall will be an effective professional to the client no matter the client's actual situation, needs or preferences.

The problem with many rating systems is that they do not necessarily correlate with success in a particular market or sub-specialty. For example, a lawyer who is successful at litigating highway accidents may be much less effective at litigating commercial accidents or construction accidents. Likewise, a particular doctor may have a good working knowledge of one aspect of the human body and virtually no experience in complications arising because of HIV, adjustments for pediatric care or other valuable information. Moreover, an accountant who is well versed and highly skilled at helping mid-sized companies may have little experience or expertise in assisting start-up companies or companies in a particular industry.

This correlation may be even more remote on internet search engines. The search engine result page (SERP) ranks web-pages by the order on the page the results are presented. However these results are generally correlated to the webpage's content relative to the search terms, as well as the quantity, quality and relevance of inbound links received to that webpage and website, from other websites. Thus, in the case of the real estate market, an agent may discuss a neighborhood in its webpage content or blog about the neighborhood based on a single sale in the area. By so doing, the agent may rank higher in the SERP's, yet, the agent may have little experience in the neighborhood as compared to another agent who has not expressly mentioned the area on the website, but may have had dozens of sales in the relevant neighborhood.

These results may be further manipulated by search engine optimization (SEO) specialists who hone in on specific search terms to bring a webpage's results higher in the SERP's. This may result in the SERP ranking elevation of a profession, in this example a real-estate agent, who understands SEO, but does not necessarily understand how to sell a house, much less a house in the neighborhood or having the characteristics at issue. In other words, the real estate agent may be able to rank well about houses in a neighborhood or of a particular type without actually having relevant sales experience.

These deficits in the currently available information and search engines are very difficult to remedy for the common client. Obtaining accurate information about a professional's ability to perform a procedure or provide a particular service with relevant characteristics is often near impossible. For example, a testimonial that a doctor did a great job on removing a gall bladder may mean little as to the doctor's ability to perform other types of surgery. Thus, there is a significant need for a method and system which enables a client to obtain information about a professional that would be most desirable for their particular situation.

### SUMMARY OF THE INVENTION

It is an object of the present invention to provide an improved service system for matching consumers in need of particular procedures or services with professionals having relevant experience.

According to one aspect of the invention, a web service system or other computer based program returns proposed professional matches based on procedure characteristics. More specifically the web service compares the details of a desired procedure against details of a professional's history of procedures or services, whether it be procedure price, location, outcome, special circumstances or other characteristics. (For ease of reference, the program or method of the present invention will be referred to as a “web service,” although a non-website based system is contemplated and is within the scope of the invention). The web service then returns proposed professional profiles ranked according to their experience relevant to the procedure. These dynamic results provide a better estimate of professional experience with a procedure and any associated special characteristics than a generic professional rating.

According to another aspect of the invention, the web service system may rate the professional based on impartial outcome information from public and/or private data. This reporting may be enforced because the procedure data is required to be placed into the web service system such that the web services' owner may be paid its part of the commission and the client may be paid their rebate. In other words, the web service or system may calculate how close a professional came to obtaining the desired outcome. Other data sources may be mined as well to verify the outcome data.

It is another object of the present invention to provide an improved search engine result pages (SERP's) with relevant experienced service providers.

According to one aspect of the invention, a search engine returns service provider matches in the SERP's based on areas of expertise or experience. More specifically the web service compares the search terms against an service provider's history of procedure outcomes, whether it be price, location, nature of the procedure or procedure type, or other characteristics. The web service then returns proposed service-provider results ranked according to their experience as related to the search terms. These results provide a better estimate of provider experience with a particular procedure or professional specialty relative to the consumer's particular needs or characteristics than a generic agent website content result.

These and other aspects of the present invention are realized in a web service or system which matches procedure characteristics with relevant professionals or service providers, as shown and described in the following figures and related description.

### BRIEF DESCRIPTION OF THE DRAWINGS

Various embodiments of the present invention are shown and described in reference to the numbered drawings wherein:

FIG. 1 shows a flow chart overview of the interaction between the web service subsystems;

FIG. 2 shows a flow chart of an embodiment of the client interface portion of the web service system;

FIG. 3 shows a flow chart of another embodiment of the client interface portion of the web service system;

FIG. 4 shows a diagram of system interactions in the web service system;

FIG. 5 shows a diagram of the procedure characteristic to professional ranking module for doctors;

FIG. 6 shows a diagram of the procedure characteristic to professional ranking module for attorneys.

FIG. 7 shows a screenshot of the buyer invitation to use the a home-agent match web service system;

FIG. 8 shows a screenshot of the seller information survey system;

FIG. 9 shows a screenshot of the agent recommendations and the interface to the vetting module on a display screen;

FIG. 10 shows a screenshot of the bid comparison interface to the customer bid review and acceptance module;

FIG. 11 shows a screenshot of the agent profile interface to the agent database module;

FIG. 12 shows a screenshot of the agent results interface tab to the buyer search module on a display screen;

FIG. 13 shows an alternate screenshot of the information survey system as seen in FIG. 7;

FIG. 14 shows a screenshot of another embodiment of the agent recommendation interface and vetting module;

FIG. 15 shows a screenshot of another embodiment of the bid comparison interface to the customer bid review and acceptance module;

FIG. 16 shows a screenshot of the agent bid request interface;

FIG. 17 shows a screenshot of the agent submit seller proposal interface;

FIG. 18 shows a screenshot of the agent submit buyer proposal interface;

FIG. 19 shows a screenshot of the agent claiming interface;

FIG. 20 shows a screenshot of the manage client interface;

FIG. 21 shows a screenshot of the interface to the lead management subsystem;

FIG. 22 shows a screenshot of the auction proposal interface.

FIG. 23 shows a diagram of the interaction between the web search servers;

FIG. 24 shows a flow chart of the term-experience matching subsystem;

FIG. 25 shows a diagram of the professional experience to search term ranking subsystem;

FIG. 26 shows a search engine result page with organic experienced professional results;

FIG. 27 shows a search engine result page with profile enhanced organic experienced professional results;

FIG. 28 shows a search engine result page with organic experienced professional results and advertising that includes relevant certifications;

FIG. 29 shows a search engine result page with profile enhanced organic experienced professional results and advertising that includes relevant certifications;

FIG. 30 shows a search engine result page with professional results as supplemental to the organic result for the domain;

FIG. 31 shows a search engine result page with profile enhanced professional results as supplemental to the organic result for the domain with advertising that includes relevant certifications;

FIG. 32 shows a search engine result page with certified professional results as supplemental to the organic result for the domain;

FIG. 33 shows a website search with certified professional results related to the search and website; and

FIG. 34 shows a diagram of a data collection server and its connection to other content servers.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

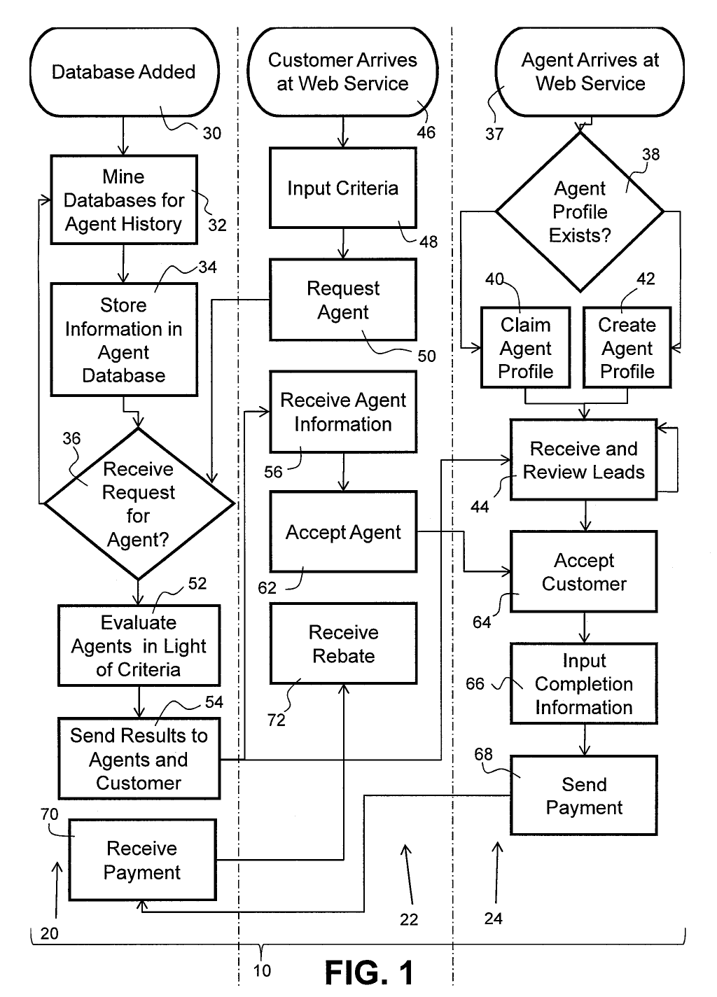

Turning now to FIG. 1, a flow chart is shown providing an overview of the interaction between a system for identifying a professional having relevant experience 10 and subsystems 20, 22, 24. (It should be recognized that one implementation of the present invention is a web service wherein a consumer may search for relevant professionals. However, other systems, such as a client server/private network, search engine searches, and the like may also be used and should be deemed, unless noted otherwise, to fall within the scope of the invention).

An information management subsystem 20 communicates with a client subsystem 22 and a professional subsystem 24. These subsystems 20, 22, 24 interact with the purpose of matching characteristics of a procedure or desired procedure with a professional that has the most relevant experience and success in similar procedures. This may include relevant experience such as procedure price, location, outcome, special circumstances or other characteristics which may be important to procedure clients.

The information management subsystem 20 begins processing when it discovers a new data source and adds a database 30 (or supplements records of an existing database) for that source. Current data within the new database is mined 32 such that it may be associated with a professional's history in the professional database 34. Until a request for a professional is received 36, the information management subsystem 20 continues to monitor the data source and mine any new data 32 for association with a professional's database 34.

Meanwhile, a professional may arrive at the web service interface 37 for the first time. If the professional's information is already in the database and the professional's profile exists 38, the professional may claim the profile 40. Otherwise the professional will be required to create a new profile 42 for inclusion in the database. Once the professional has a profile, she may check back from time to time to review any current client requests (leads) or receive new leads 44. Likewise, the professional may be notified of any new leads by a communication such as an email, text message, etc.

Meanwhile, a client may arrive at the web service interface 46. The client inputs his desired or actual procedure criteria 48, such as any variety of procedure characteristics. The client then submits the information to the information management subsystem 20 to request a professional 50. It will be appreciated that the procedure can be any of a large number of services. While discussed herein as relating to doctors and lawyers, the service could be accounting services, resolution of tax problems with government agencies, the sale of a business, the negotiation of a funding round for a growing business, development of an advertising campaign, the sale of expensive items such as jewelry or a yacht, obtaining life or health insurance or even the construction of something such as a building. For example, a land owner could use the system to find a contractor to build an office building and the contractor could use the system to find subcontractors for the project. Thus, it will be appreciated in accordance with the present invention that a procedure as used herein can refer to many different services.

In one embodiment, the subsystems then begin interacting with the purpose of matching characteristic information about the procedure submitted in 48 to a professional's history mined in 32. Each professional having a history in and/or servicing the procedure area submitted in 48 is evaluated against those same procedure criteria 52. The system returns one or more professionals 54 and communicates the results to both the client subsystem 22 and the professional subsystem 24. This may be by simply providing a list of professionals having experience relevant to the procedure, or by a ranking of the relevancy of the experience. Thus, for example, an accountant who had negotiated dozens of tax settlements for small companies would have a higher ranking than an accountant who had only done a few or had done many for large companies when the search characteristics were for tax settlements for a start-up company.

Both the client in 56 and the professional in 44 receive the results of the request in 50. The client receives a portion of the professional information 56; the professional receives a portion of the client information 44. If the client accepts the professional 62 and the professional accepts the client 64, the professional begins work on a finalizing any terms necessary to finalize a professional-client relationship. After reaching an agreement, the professional then works with the client to complete the desired procedure.

Upon completing the procedure, the information is input into the professional subsystem 66 along with payment information 68, which is communicated to the information management system 20. This may include results of the procedure and whether the client was satisfied with the services provided. The information management subsystem 20 receives the payment 70 and rewards the client with a rebate 72 of a portion of the payment received 70.

In one embodiment, outcomes are monitored for the matched professional and client. For a doctor, a smaller than expected recovery period and the amount of residual pain may be noted and stored as part of the professional's history with that sale. For an attorney, similar statistics may be gathered and stored evidencing such characteristics as quick resolution, small settlement, lower cost or other desirable characteristics. If no transaction is forthcoming, that failure may also be stored. Thus, the particular success of the professional may be dependent on performance of each procedure or transaction processed through the system.

Likewise, for other types of procedures, information can be entered, such as, the time to complete the procedure, whether the cost was in line with the estimate, the satisfaction of the client, as well as characteristics which help distinguish one procedure from another. In other words, the type and size of the procedure (painting a house vs. painting an office building), and geographical location, and other relevant aspects of the procedure can all be used to help find providers who are most likely to perform well for a given task.

The type of information about a given procedure may include, but is not limited to:

Data attributes that may be used by the system to recommend service providers to a customer include:

### Service Provider Information: e.g.

State license status
Number of past complaints with the state department
Number of active complaints with the state or Better Business Bureau

Office Location
Number and percentage of repeat customers
Languages spoken
Gender of service provider
Age
Total number of referred customers over a given timeframe
Success of previous procedures
Publicly and privately available 3rd party ratings
   Analysis of 3rd party reviews
Internally sourced ratings and reviews

### Procedure Information: e.g.

Location of procedures performed
Type of procedure (e.g. sale of business, tax dispute resolution, divorce, construction of building, etc.)
Size of procedure (e.g. sale of $100 Million company, settlement of $5000 tax lien, multimillion dollar divorce, $1 Million Office Building etc.)
Size of client (i.e. individual, small company, large company, etc.)
Other relevant attributes of client (e.g. female divorce client, male gall stone patient, obese knee replacement, start-up company, etc.)
Number of procedures during a given timeframe
Client rating of procedure timing, outcome and other comments.

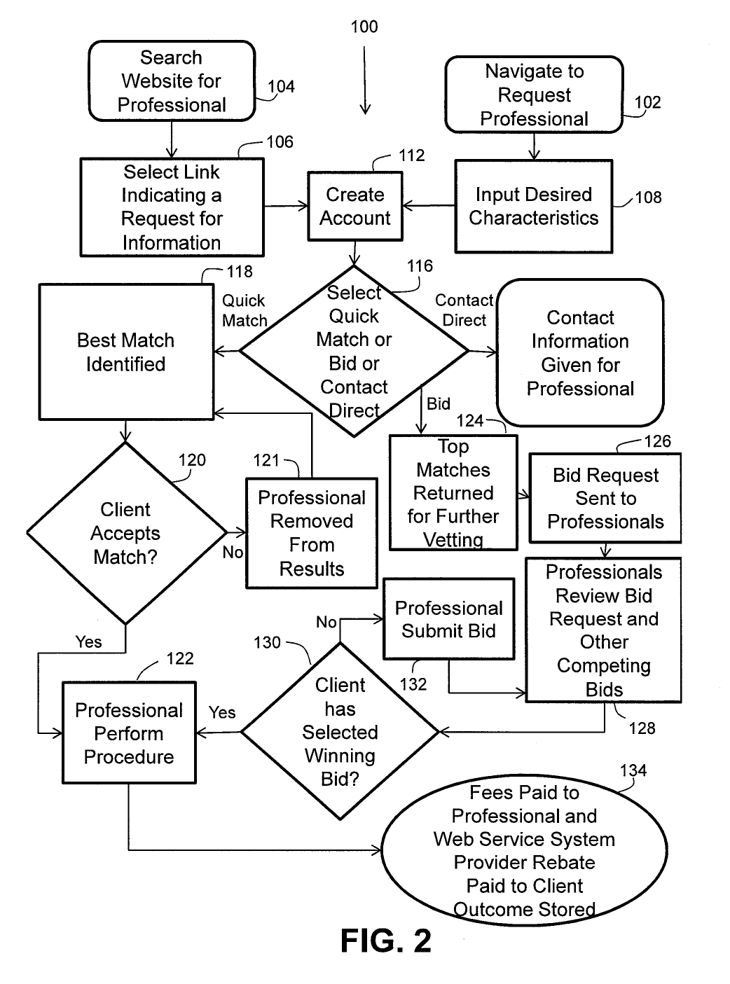

Turning now to FIG. 2, a flow chart of the client interface portion 100 of the web service system 10 (FIG. 1) is shown. The client interface portion 100 may be used to perform actions 46, 48, 50, 56 and 62 of FIG. 1 and effectively serves as part of the client subsystem 22. A client who wishes to find a professional navigates to the request professional page 102 of the web service system 10 or searches for a professional 104. The client may then input the characteristics of the procedure to be performed 114. This may be partially autopopulated by selecting a link 106 or input directly 108. An account may be created 112 to store the search and prepare for further interaction with the system. The client may then choose to have the system match the client's procedure with the most highly relevant professional, a quick match, or may have a group of the most highly relevant professionals bid to service the client 116.

Should the client select the quick match, the web service system 10 compares the procedure characteristics with the professional's experience and selects the best match of a professional with the procedure characteristics 118. If the client does not accept the match 120, the process may be repeated by removing the previously selected professional from the results 121. The next best match is then returned. Once the client accepts the professional, the client and the professional may begin their process of negotiating the procedure parameters 122.

If the professional does not accept the client within a predetermined time frame, the system may then send the client request to the next best match for the client's input desired characteristics. Likewise, a client can refuse a certain professional after a request is made, based on the professional's response or other factors and the process can repeat itself until a suitable professional is obtained by the client.

If the client selects to have the professionals bid on the project, the web service 10 returns a listing of the top professionals match according to the procedure's characteristics and allows the client to remove any of the matched professionals 124. The remaining professionals may then be sent a request for a bid 126. The professionals may then review the bid request and any other competing bids 128. If the client has not already selected a bid 130, the professional may submit or modify their bid 132. Once the client selects a bid 130, the professional and client may begin their process of finalizing the procedure parameters 122. Such a scenario enables professionals to bid competitively for work which they find most appealing, and gives the client the ability to obtain concessions such as larger rebates, scheduling or other desirable terms that result from marketplace transparency. These terms may include a competitive hourly rate or a fixed fee for a given procedure.

The web service system allows the client an opportunity to refuse any of the professionals based on their personal biases. This vetting module is useful to prevent the wasting of time of a professional to bid on an opportunity, when the client would never select a professional based on some characteristic. For example, some clients may require a doctor of the same sex because of embarrassment or religious issues. Likewise, a woman in the process of getting a divorce may wish to be represented by a woman. Similarly, a person may seek a service provider who speaks their native language or who is likely to have other things in common which may facilitate providing the service in a manner desired by the customer.

Once the procedure has been completed, the professional has the duty to report the outcome through the web service system 10. The fee may be paid to the professional, who forwards the required portion to the web service owners. A rebate incentive paid to the client ensures that the client has an interest in enforcing the professional's submission of the outcome (including information related to the procedure, outcome and the professional's compensation) into the web service system 134.

For example, an attorney with non-disclosure agreement litigation experience may be requested. The client may select to have attorneys bid for the work. Part of the bidding may be on a contingency fee basis, where the contingency percentage of the settlement/award may be negotiated. The client may then select the experience level and contingency percentage as weighed by the comparison of other attorneys and bids.

While the jurisdiction may forbid paid referrals to attorneys, a transaction fee for processing payment, customer relationship management system use, and/or bid management may be appropriate. In another embodiment, a monthly listing fee is charged. The system can pay the client the desired rebate for documenting completion of the procedure out of the monthly listing fee.

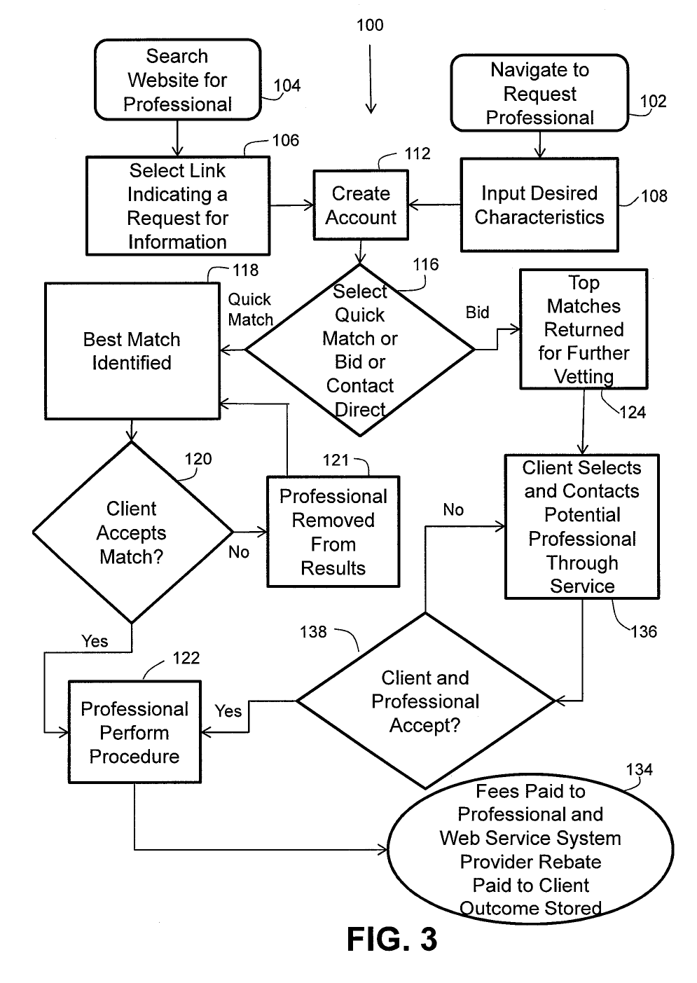

Turning now to FIG. 3, a flow chart of another embodiment of the client interface portion of the web service system 10 (FIG. 1) is shown. In some cases, a bidding process is undesirable and a client would rather use the web service to investigate and select the most appropriate professional. For example, a multiple bypass heart surgery patient might not wish to select the lowest bid among doctors willing to bid for work. It may be more advantageous to receive a set of recommendations of the top doctors for the client's specific needs. The customer may be able to weight the factors considered. Thus, for example, if seeking a heart surgeon the customer may weigh the results almost exclusively on experience, while a customer having a clogged drain opened may heavily weight the computation of results toward a low price and quick response time.

The bidding process (as seen in FIG. 2) is replaced by selecting potential professionals and contacting them through the service 136. The client and the professional then both accept the proposed procedure 138 and then work toward performing the procedure.

A professional profile interface link may be available during the professional selection portion of the system. The professional profile may contain some of the information collected about the professional by the web service system. This may include contact information, current expertise, past work history, blog links/posts, academic papers, client reviews, answered questions, twitter posts, recommendations, complaints, disciplinary actions, statuses of licenses and permits, and other information gathered by the web service system. The information may be further condensed into summary statistics. For example, a professional's procedure data may be summarized into a most common procedure, average wait, and geography serviced in order to typify or profile each expert based on their sub-specialties and areas of expertise.

The professional profile may serve as a reinforcement of the procedure-professional matching system. After receiving a recommendation by the system, a client may browse the professional's profile to gain confidence that the professional services similar procedures. When the client views the professional's data listings, history and reports, the client may feel more comfortable in the professional's knowledge. This may be further bolstered by other gathered data such as blog posts, twitter posts, customer reviews, and their authored answers to past system-user questions.

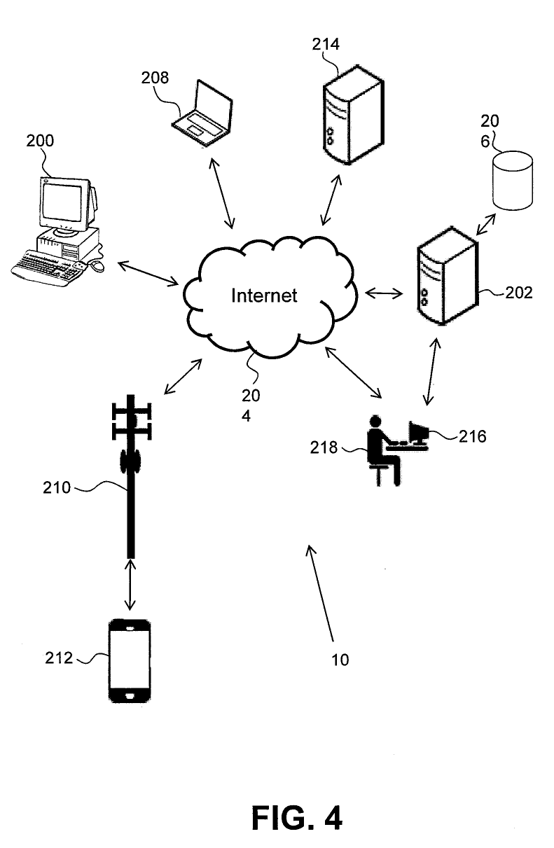

Turning now to FIG. 4, a diagram of system interactions in the web services system 10 is shown. A client computer 200 (i.e. screen, processor, etc.) may contact the web service system server 202 through the internet 204. When a search is requested, the web service server 202 may request data from internal local or network database servers 206 to make the ranking decisions with the professional history compared with the client submitted procedure characteristic data and possibly other personal characteristics (age, sex, credit score, income). Once a professional has been selected for contact, the professional may receive notification from a number of different sources including email on a personal computer 208, a text message sent through a wireless carrier 210 and delivered to a mobile device 212 (i.e. screen, processor, etc.). The professional may also use similar methods to contact the web service server 202 to review any potential clients.

The web service system server may also be connected with other services. For instance, the Center for Disease Control (CDC) National Center for Health Statistics 214 data may be queried for data on the likelihood of a good outcome, procedure verification and other important status. Similarly, the local department in charge of licensing may be queried for disciplinary action, an active license and other information available. Other data sources may be similarly queried for useful data to be included in the database servers 206. Should any problems be detected for client requests received, the web service system server 202 may communicate with a client support system 216 for follow up by a client support representative 218.

The external data may also be supplemented with internal data that is not available anywhere else. For instance, the outcome of many legal cases is confidential and not available to the general public. However, the attorney may still be required to disclose the outcome to the web service system with sufficient detail to enable evaluation of the attorneys' performance, during the profile claim process and in order to participate and receive procedure requests (new business leads). Such information will not publicly disclose the outcome, but the web service system can use it in later evaluations. As this data is not available elsewhere, it may provide a competitive advantage for this system.

The web service system may require professional pre-approval based on an acceptance of terms of service from the professional and an experience check. The pre-approval may further assure clients that poor performing professionals have been vetted from the system. It may also assure that any professional is contractually bound to pay the appropriate portion of the sales price to the owner of the web service system.

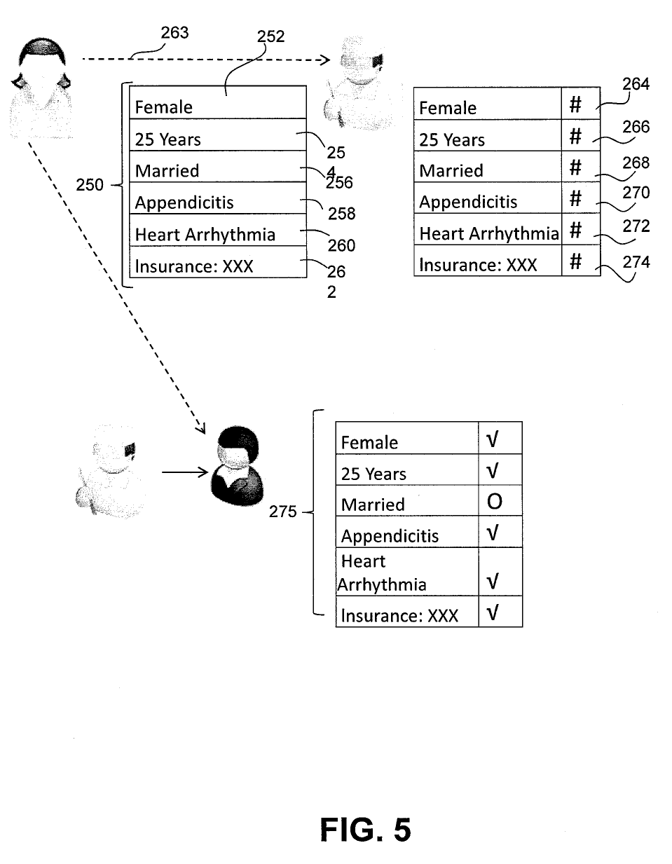

Turning now to FIG. 5, a diagram of the procedure characteristic to professional ranking module is shown. The client is requested to fill out a survey of the procedure's characteristics for use in the procedure-professional matching system and other important data. This data may then be used to dynamically rate a professional's experience in performing similar procedures.

Using procedure characteristic data 250 entered by the potential client, each data field is compared with the stable of procedures sold by the professional. The advantage of the system is that a professional's experience is matched to the procedure characteristics. A doctor that normally performed pre-natal care procedures may be inexperienced in performing high-risk pre-natal care procedures on women in an advanced age because the needs, risks and trade-offs are different. Likewise, an attorney well versed in performing high value estate planning, may have little experience with low value estate wills and the like. Thus, in accordance with the present invention, it is desirable to improve the match between the client's needs and the experience of the professional who will be working with the clients.

In one embodiment, the gender 252, age 254, marital status 256, procedure type 258, special needs 260, and/or insurance carrier 262 are compared 263 against the number of procedures performed by the professional with similar gender 264, age 266, marital status 268, procedure type 270, special needs 272 and/or insurance type of procedures previously performed 274. This is referred to herein as a professional experience match system.

In an alternate embodiment, each procedure performed by the professional 275 is rated on the procedure data 250 provided by the client as well as the general outcome, if known, which may be presumed via the absence of certain other data, such as law suits, claims of malpractice or negative customer reviews found on the Internet (by a system which may actively search the Internet for such references and report back). Each professional procedure rating may then be aggregated to form a match rating. This is referred to herein as a professional procedure match system.

Each of the professional procedure criteria may be weighted such that inexact matches contribute a partial rating, such as a 28 year-old age contributing a partial rating to a desired 25 year old age, because of the close proximity to the desired result. These rating weights may be based on a selected importance by the client or pre-set by the web service system.

Further, static data may also be included in the result matching system. For example, it has been noted that there is likely a correlation between response time to a client request, level of due diligence by a professional prior to a procedure, communication, empathy, and a positive client outcome. Therefore, a professional may also be rated on these criteria.

These static data points may be pre-compiled and stored along with the professional's other static data, such as contact information. When the procedure-professional matching system is requested by a client, a portion of the professional rating may depend on such static data, but the rating overall is dynamic, based on the procedure characteristics submitted.

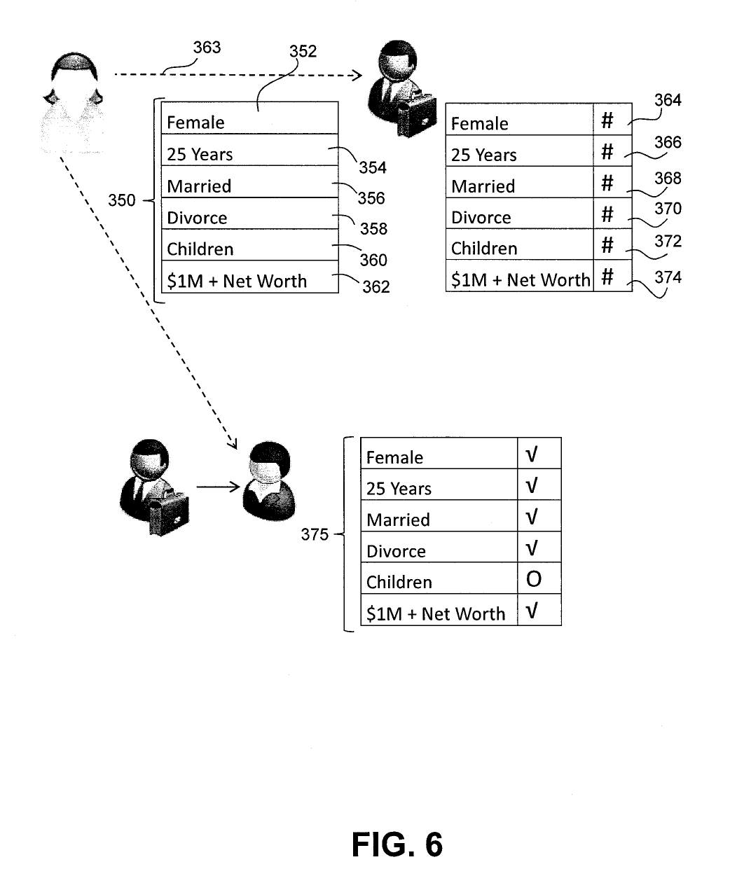

Turning now to FIG. 6, a diagram of the procedure characteristic to professional ranking module for attorneys is shown. The client is requested to fill out a survey of the legal problem characteristics 350 for use in the attorney matching system. This data may then be used to dynamically rate an attorney's experience in solving similar problems.

In one embodiment, the gender 352, age 354, marital status 356, procedure type 358, special needs 360, and/or net worth 362 are compared 363 against the number of procedures performed by the professional with similar gender 364, age 266, marital status 368, procedure type 370, special needs 372 and/or net worth of procedures previously performed 374. This is referred to herein as a professional experience match system.

In an alternate embodiment, each procedure performed by the professional 375 is rated on the procedure data 350 provided by the client. Each professional procedure rating is then aggregated to form a match rating. This is referred to herein as a professional procedure match system.

After gathering a rating for attorneys that could service the client, the highest rated attorneys are returned for review by the client. The client may then choose the attorney that appears to suit him the best. In another embodiment, the client may request the attorneys to bid for the work.

While the focus of the discussion has been on doctors and attorneys for clarity, it should be appreciated that other professional matching would be similar, including plumbers, electricians, midwives, etc. While specific data fields may be different, the desired fields may be compared against the professional's past performance to prepare a valuation of that professional. Each procedure will include specific information which will be beneficial to the prospective client. For example, whether a plumber has experience in new installs in high-rise buildings will be important to a contractor looking for a subcontractor, but may have little relevance to a home owner who has toilet that needs to be replaced.

Likewise, a person who is looking to get funding for a small business may be much more concerned that an agent can get a loan in the $250,000 to $500,000 range, than an agent has successfully completed 25 funding rounds over $10,000,000. The person who has been successful at much larger loans may have few contacts that will fund smaller companies, or may not be very experienced with smaller deals and unable or unwilling to provide the requested loan. By monitoring the experience of the professional, the web service system can direct the customer to the provider with a background most consistent with their needs. Because the results are dynamic, the web service system can be tailored to provide the ranking of the professional on a basis which is most relevant to the potential customer.

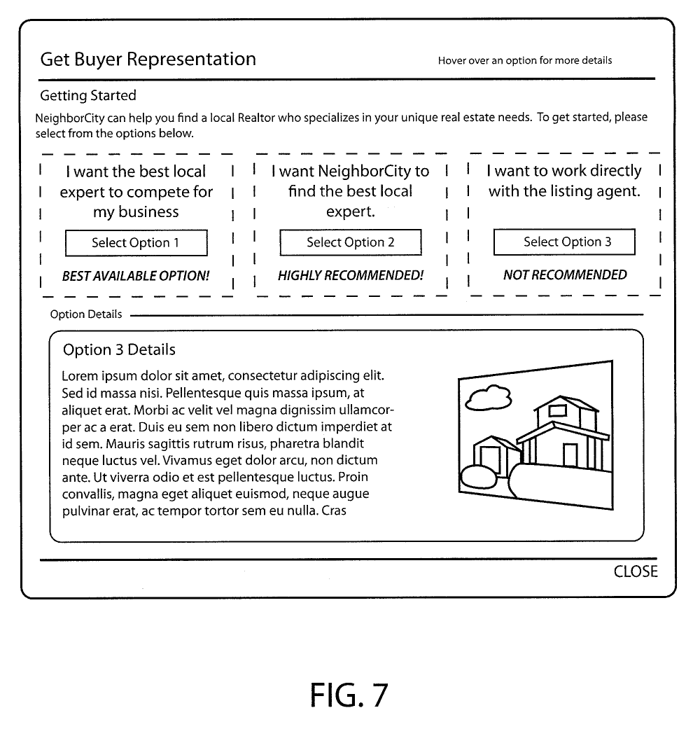

FIG. 7 through 22 show screen shots of a web service which may be used to select a professional having a desired experience set. The screen shots show use in the context of a real estate agent, and it will be understood that similar screens could be available for nearly any profession or service provider with modifications to the relevant information being collected.

Turning now to FIG. 7, a screenshot of the buyer invitation to use the home-agent match web services is shown. The buyer may select from the three options: contact the seller's agent directly, use quick match or request bids to obtain buy side agent and brokerage representation. In quick match the buyer would be provided with one of the most qualified professionals providing the service based on the information inputted. With the request bids page, the buyer would be able to select from a group of professionals and ratings may be provided to help the buyer decide.

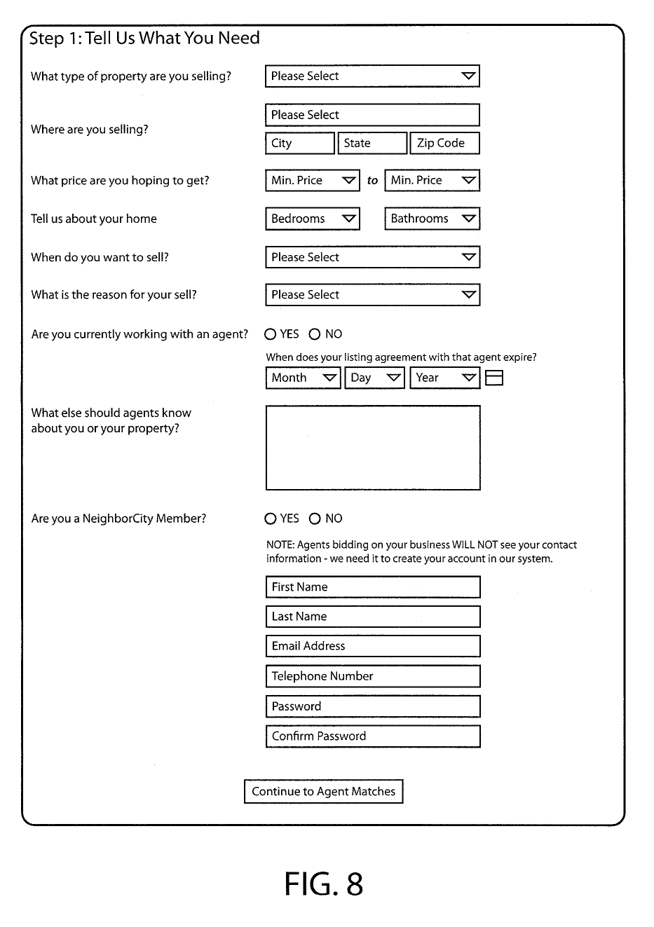

Turning now to FIG. 8, a screenshot of the seller information survey system is shown. The seller is requested to fill out a survey of the home's characteristics for use in the home-agent matching system and other important data. This data may then be used to dynamically rate an agent's experience in selling similar homes. With other types of professionals, other relevant information would be entered, e.g. type of legal problem, perceived value, desired result, etc.

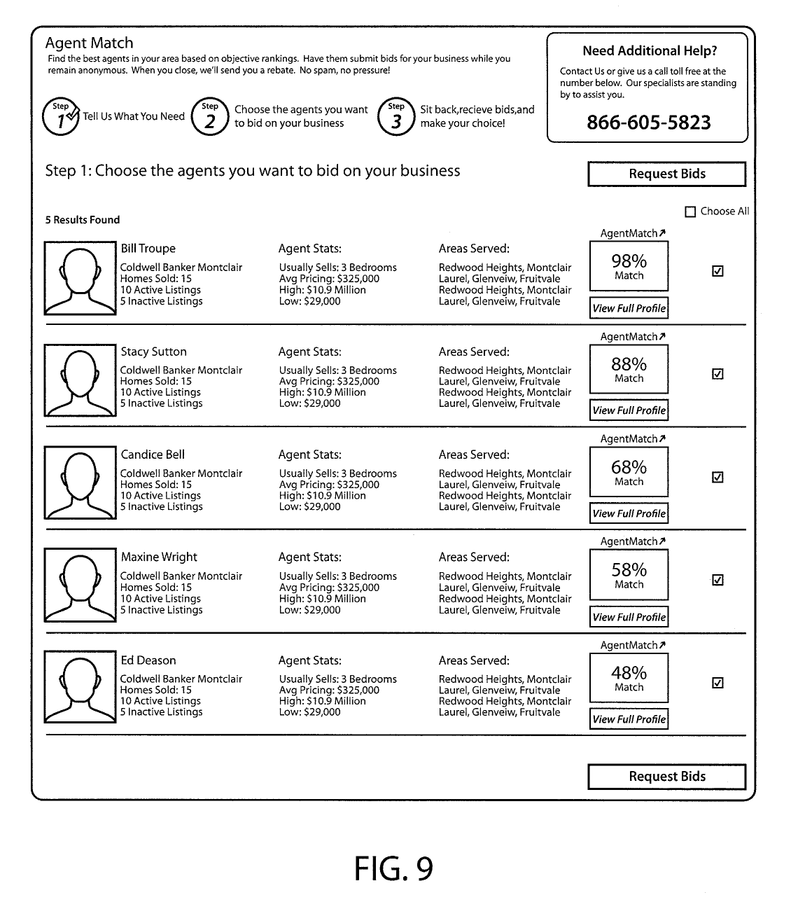

Turning now to FIG. 9, a screenshot of the agent recommendations and the interface to the vetting module is shown. If a bid is requested by the customer, the top matched agents are shown. The customer has an opportunity to refuse any of the agents based on their personal biases. This vetting module is useful to prevent an agent from wasting time to bid on an opportunity when the customer would never select the agent based on some characteristic or bias. For example, some customers may never choose an agent who worked for a national firm or an unrecognized brokerage. Likewise, a customer may prefer to have an agent who is of the same gender, same age or other characteristic so that the customer may inquire of the agent about issues which may be important to the customer. Thus, for example, a 25 year old woman may select an agent of a similar age and gender to consult on local nightlife, the dating scene and the perceived safety of particular neighborhoods. In contrast, a retiree may seek a 60 year old plus agent to gain insights about the suitability of a neighborhood and local attractions for grandchildren, etc., or amenities for the elderly. Likewise, a person may prefer an agent that speaks his or her native language over those who do not.

For other types of professionals and other service providers, relevant information could also be used. Thus, a pregnant woman could select only female ob/gyns, while an immigrant couple could select only plumbers who speaks their native language.

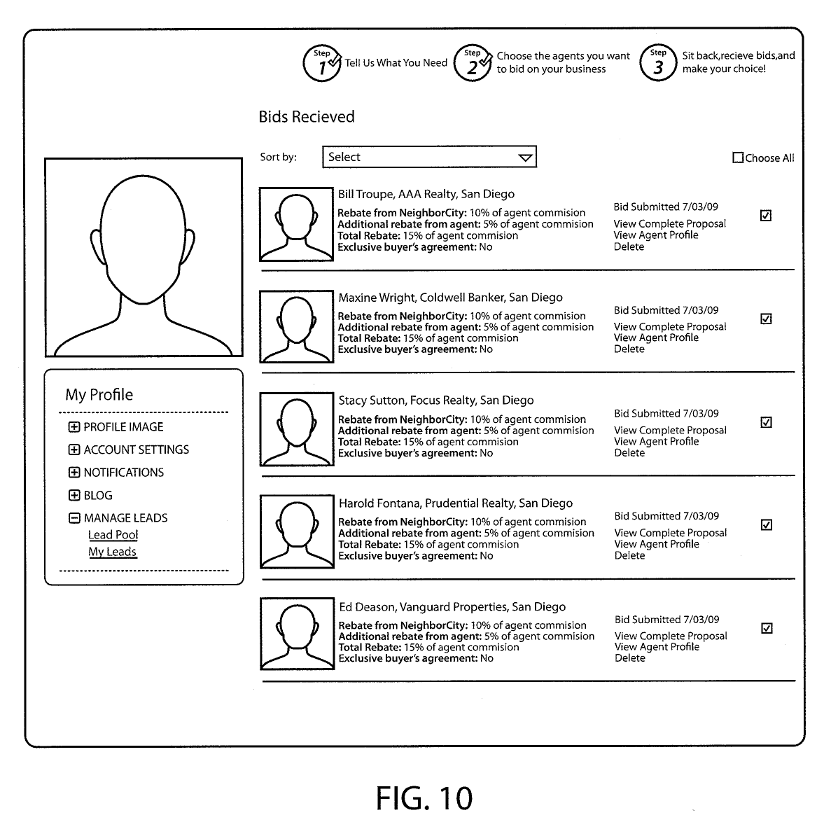

Turning now to FIG. 10, a screenshot of the bid comparison interface to the customer bid review and acceptance module is shown. The agents, having submitted bids through the web service, compete to be selected by the buyer/seller. The bid comparison screen shown is a summary/comparison screen that allows the seller/buyer to compare key statistics related to the agent representation. The customer may further drill down into the specifics of the offered representation by clicking on a link.

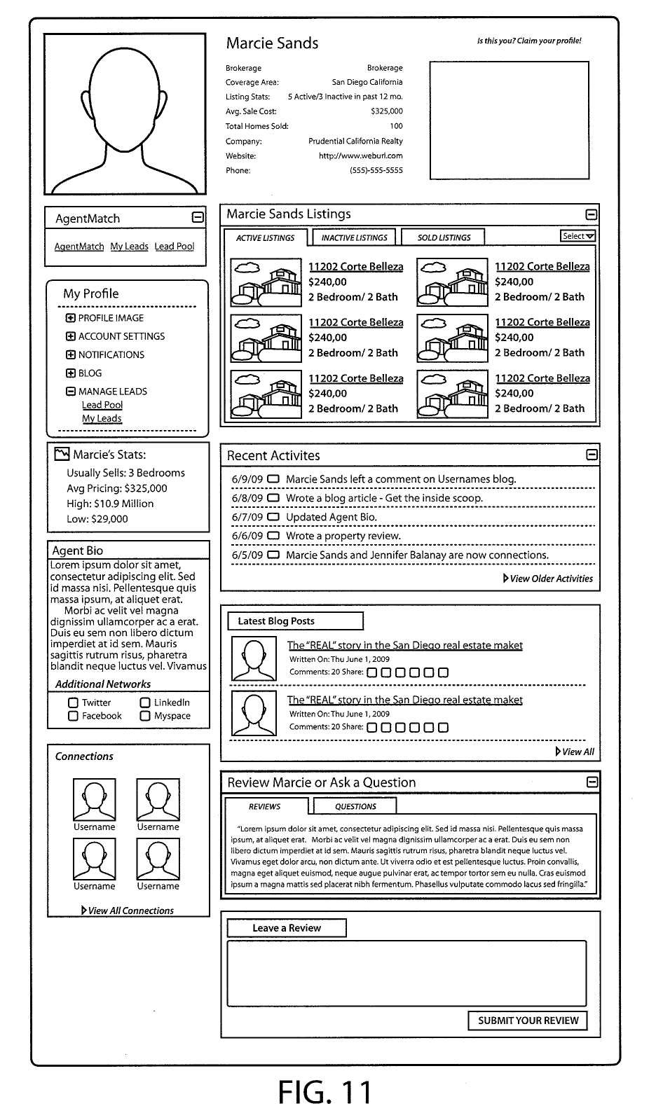

Turning now to FIG. 11, a screenshot of the agent profile interface to the agent database module is shown. The agent profile interface displays a selection of the information collected about the agent by the web service system. This may include contact information, current listings, past listings, blog links/posts, customer reviews, answered questions, twitter posts, recommendations and other information gathered by the web service system. The information may be further condensed into summary statistics. For example, as seen in the screenshot, an agent's home data may be summarized into an average price, high and low sales prices, and a usual number of bedrooms in the home sold.

The agent profile may serve as a reinforcement of the home-agent matching system. After receiving a recommendation by the system, a customer may browse the agent's profile to gain confidence that the agent services similar homes. When the customer views the agent's data listings, listing history and sales history, the customer may feel more comfortable in the agent's knowledge. This may be further bolstered by other gathered data such as blog posts, twitter posts and answers.

Likewise, information about a doctor, lawyer, plumber, contractor, IT support, etc., can be provided to a customer with a ranking of how relevant that person's experience is to the customer's particular problem. This give the customer better assurance that the service provider actually knows how to properly complete the procedure.

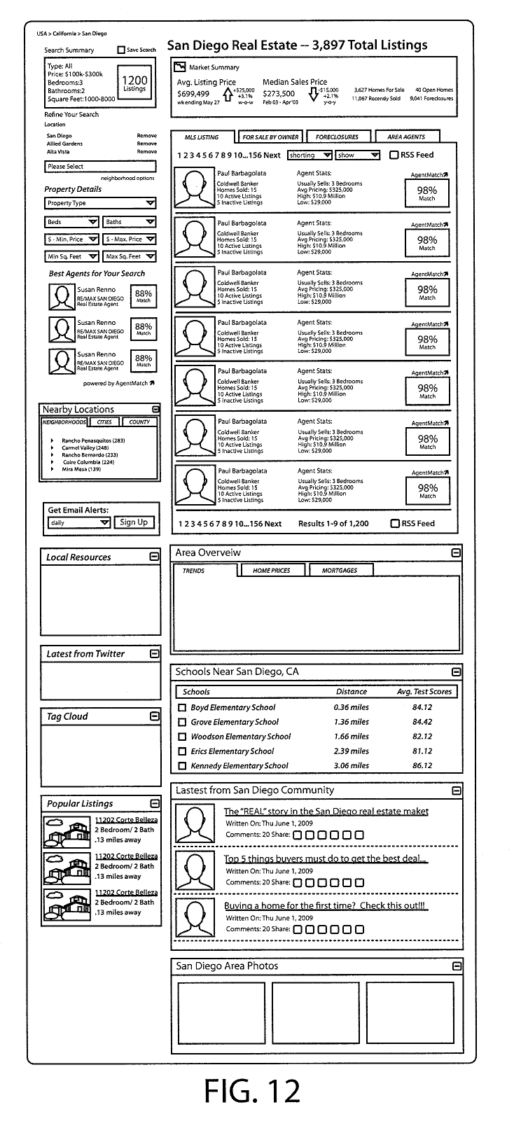

Turning now to FIG. 12, a screenshot of the agent results interface tab to the buyer search module is shown. Based on a customer's search performed for houses in a neighborhood/area, the web service populates the area agents tab with agents ranked by their score which is dynamically created based on the home search criteria input by the customer. Should the customer choose to select one of the agents, the web service system may start the quick match process with the selected agent as the result. In another embodiment, the web service will ask whether the customer wishes to request a bid from that agent or from a group of agents. This can similarly be created for other professionals and other service providers with relevant data as discussed above.

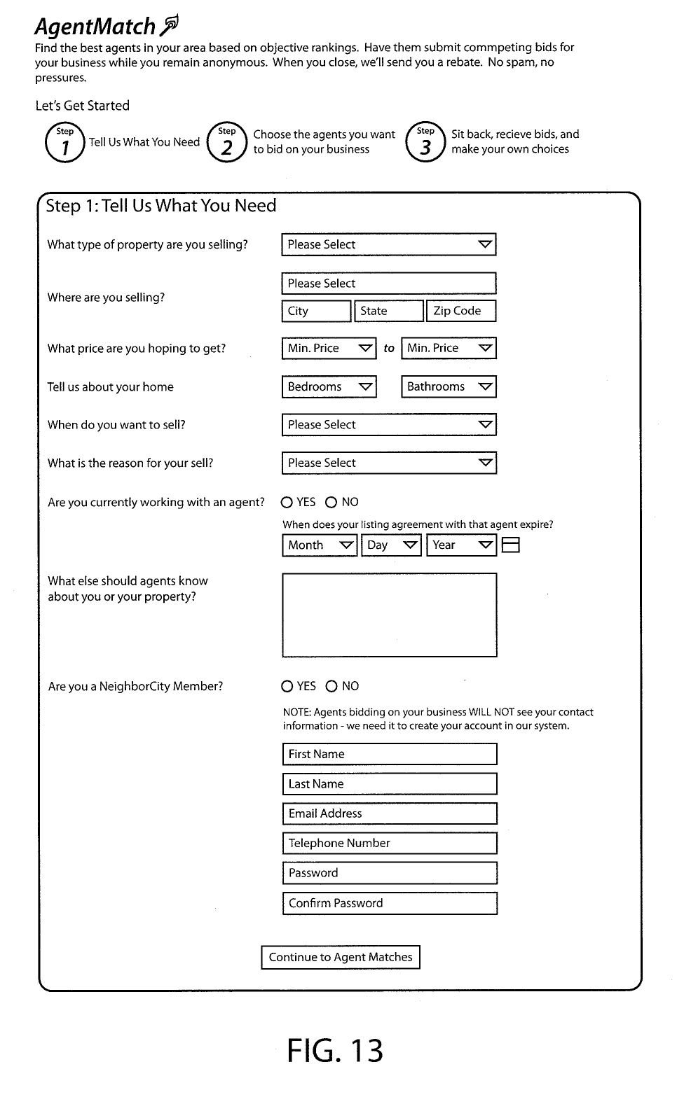

Turning now to FIG. 13, an alternate screenshot of the information survey system as seen in FIG. 7 is shown. After deciding to receive the agent match benefits, a seller is requested to fill out house characteristics that may be used by the agent match system. A seller may optionally specify a target time frame when they would like to sell their home. In one embodiment, the system may auto-populate the fields from previously stored data based on an address or MLS number. The client may then have the option to update any information that is out of date.

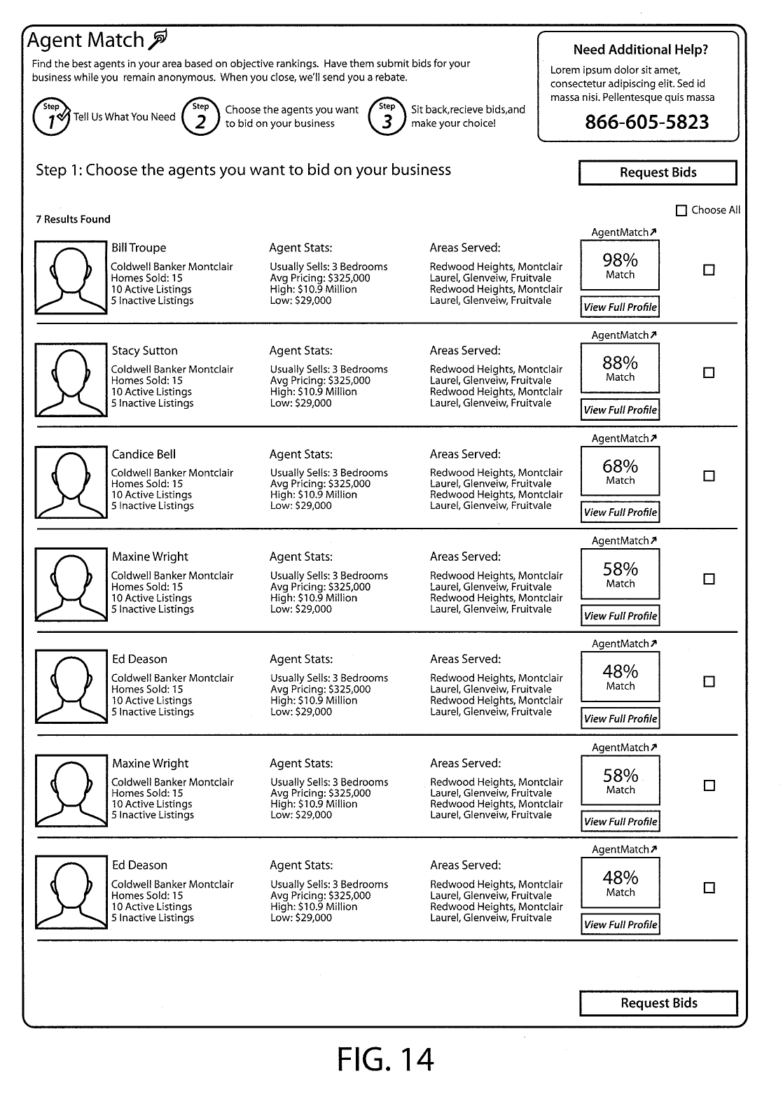

Turning now to FIG. 14, a screenshot of another embodiment of the agent recommendation interface and vetting module is shown. In one embodiment, after filling out the survey data, the client is presented with this screen on their display. Agent profiles are accessible from the agent name links, areas served are linked to area profiles, and the summary statistics of the agents are shown. The client may use any of this available data in vetting any agents from the bidding process based on their personal bias, desires or needs.

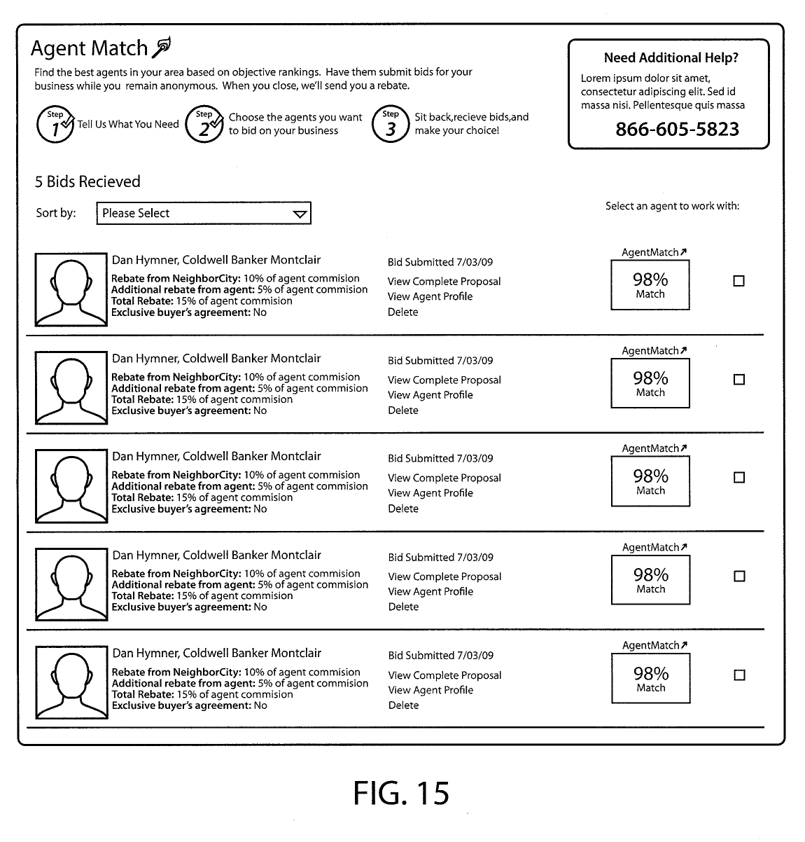

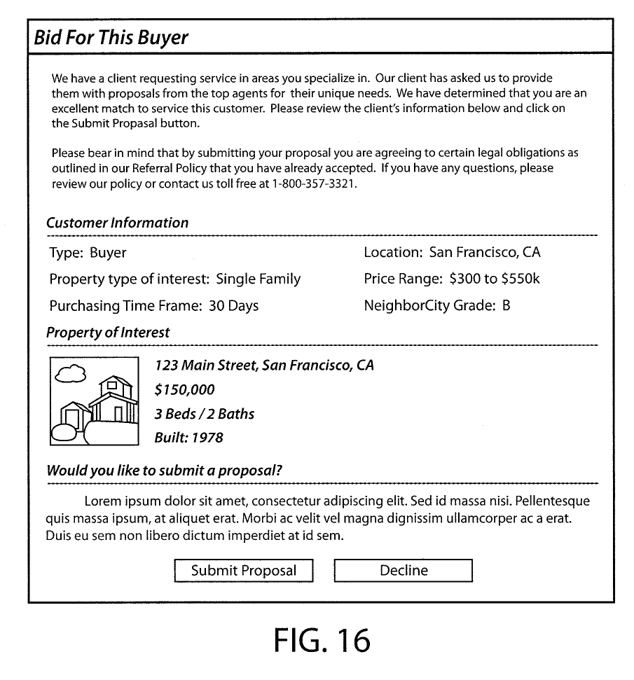

Turning now to FIG. 15, a screenshot of another embodiment of the bid comparison interface to the customer bid review and acceptance module is shown. After the customer has selected the potential agents from which to receive bids, the agents receive a message (such as in FIG. 16) requesting a bid. Any agents who submit bids will be shown on this interface and associated with their bid. Once a satisfactory bid is made, the client may accept the desired bid.

Turning now to FIG. 16, a screenshot of the agent bid request interface is shown. After a client has requested selected agents to bid, an invitation to bid is sent to the selected agents. The agent may then choose to submit a proposal, decline involvement or, in some cases, request more information Likewise, other service providers, such as doctors, contractors, plumbers or the like can submit bids. A doctor may bid on a lens correction procedure, an attorney could bid on a medical malpractice case and a contractor could bid on the construction of a barn on the respective sites for those professionals and service providers.

In one embodiment, the web service system also gives the client a rating. The web service system mines data about the client and gives them a rating. This mined customer data may include data from the survey, a credit report, or internal or external or other free or paid database requests.

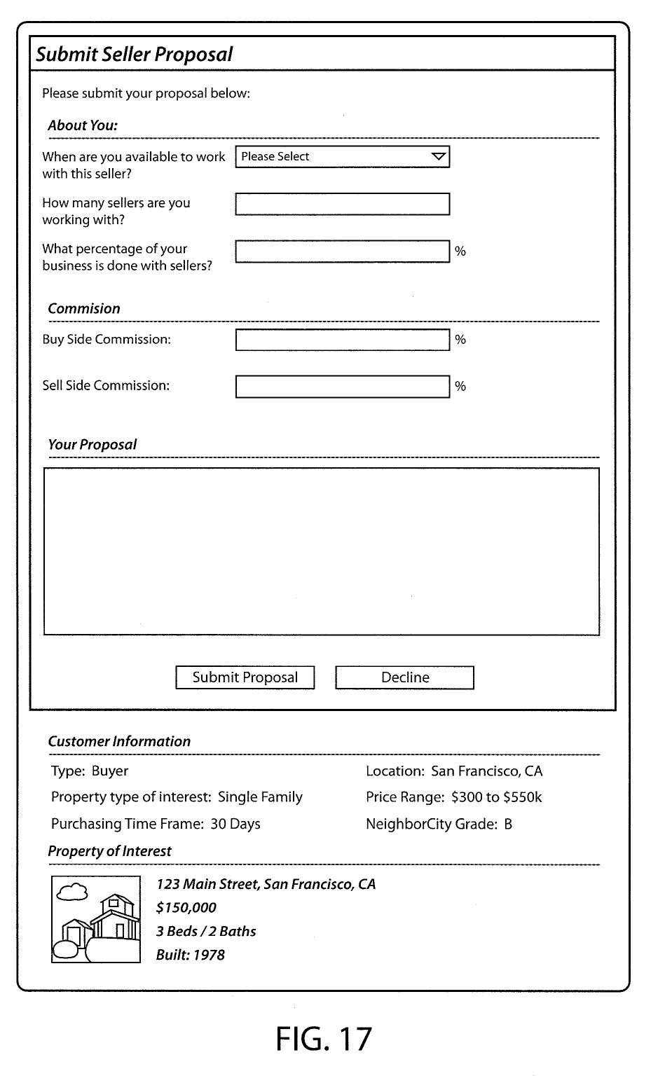

Turning now to FIG. 17, a screenshot of the agent submit seller proposal interface is shown. After having received the invitation and selected submit proposal, the agent is then requested to fill out the proposal survey. The proposal survey may include several fields for computing summary data and an information box for other terms not included in the fields. Once submitted, the information may then show up on the client bid comparison interface as seen in FIG. 15.

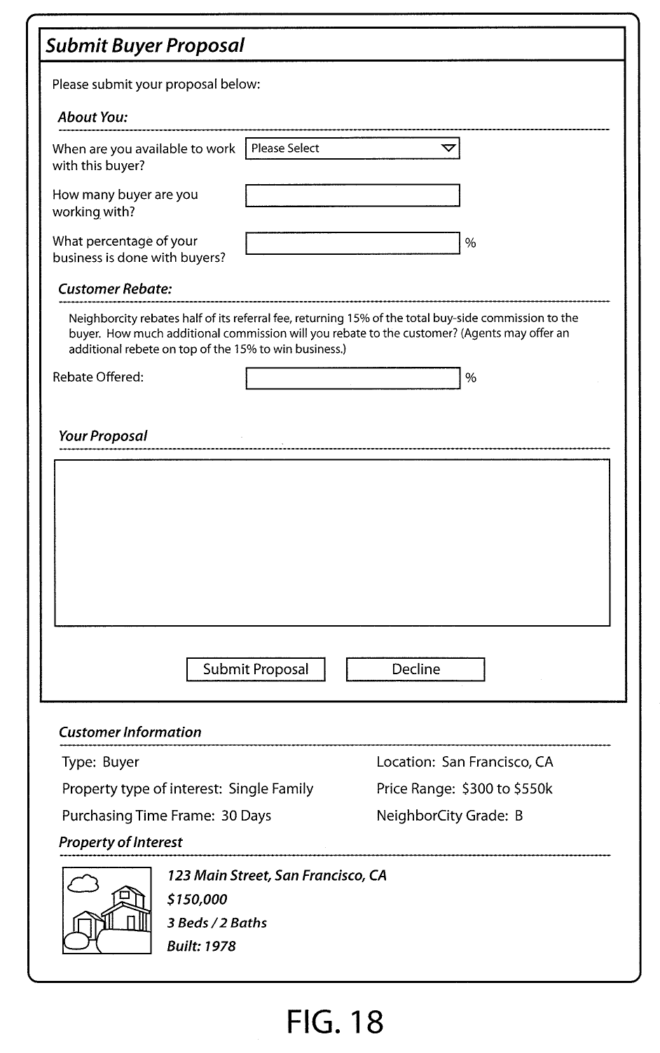

Turning now to FIG. 18, a screenshot of the agent submit buyer proposal interface is shown. Similarly to FIG. 17, after having received the invitation and selected submit proposal, the agent (or other service provider) is requested to fill out the proposal survey. This information is then relayed in a similar manner to the client.

While the screenshots show a web page, the system of the present invention may use other means of communication, such as SMS, XML, push notification, email and other technologies to ensure that the client and agent are notified of any changes in the bidding process. Similarly, the system may accept communications in modifying, submitting or accepting bids.

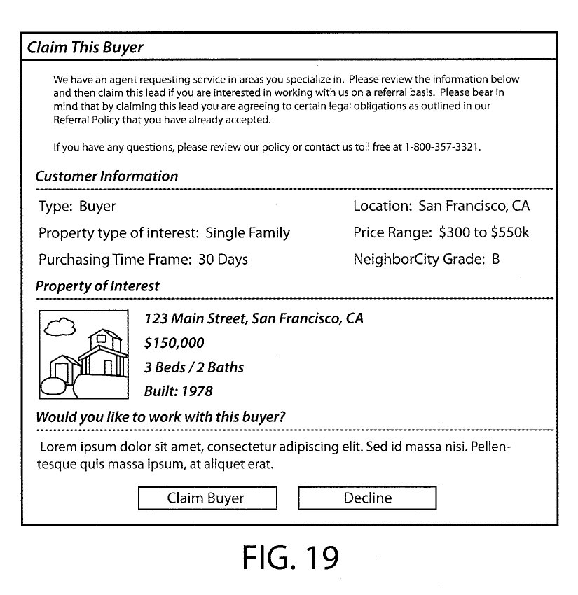

Turning now to FIG. 19, a screenshot of the agent claiming interface is shown. If the client has chosen the quick match feature of the web service system, once notified, the agent (or other service provider) may accept or decline the invitation to become the agent for the client. If the agent declines, the web service system may exclude the agent from the results and give the next highest match an opportunity.

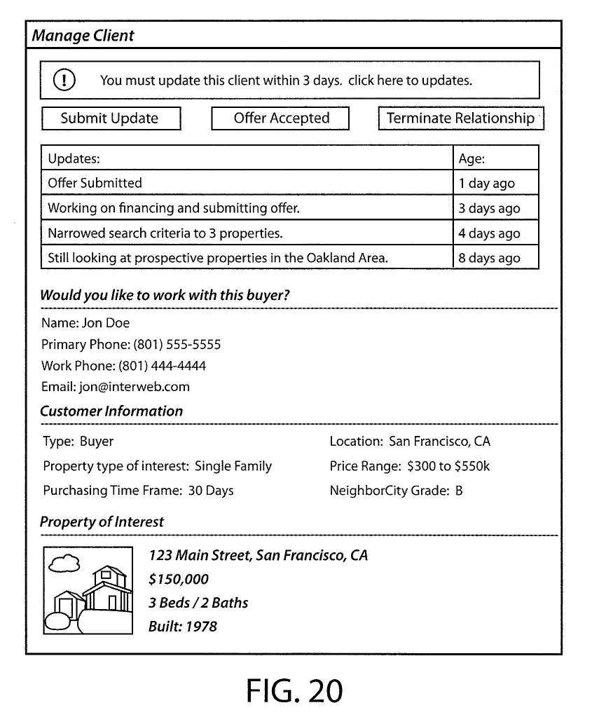

Turning now to FIG. 20, a screenshot of the manage client interface is shown. Once a relationship has been confirmed by both parties, the system may keep track of the interaction between them. In this screenshot, it may be noted that the relationship has progressed from looking in a general area (i.e. Oakland), to narrowing the search, to composing an offer, to the current status of waiting for a response. By tracking communications between the parties, current status and the history of status, the web service system may detect relationships in danger of souring and initiate alert or warning messages to the agent and customer service representative responsible for the particular customer. The customer service representative may then respond to both parties and ensure a satisfactory resolution. Further, by tracking the interaction, an agent may be rated on her attentiveness, time taken for each status step and other indicators of active client service.

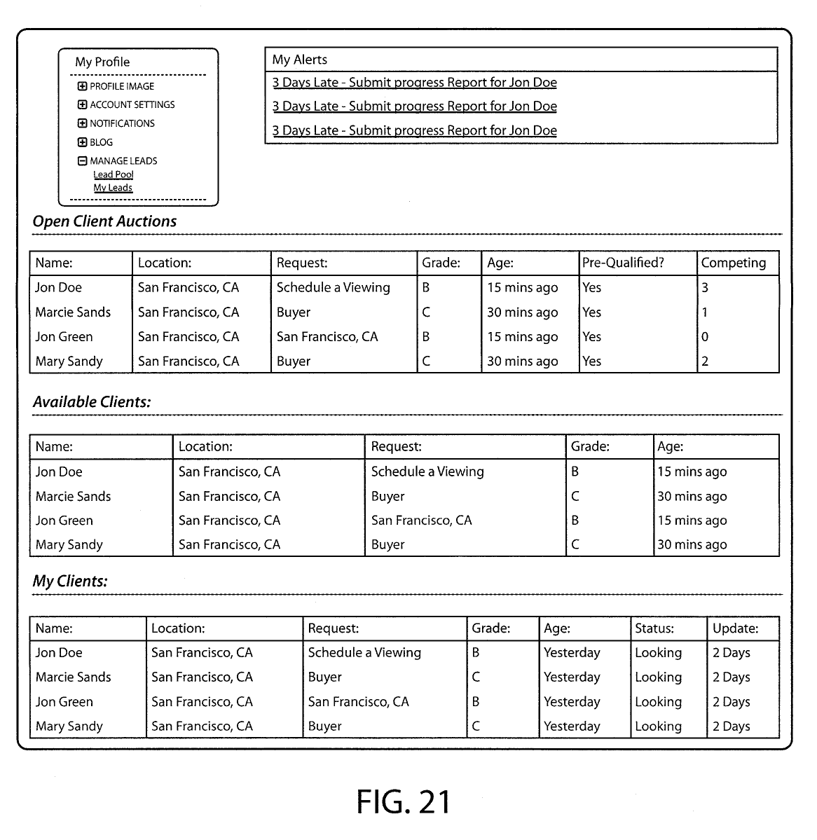

Turning now to FIG. 21, a screenshot of the interface to a lead management subsystem is shown. An agent may actively manage their workload in the web service system by ensuring that current clients are recently contacted and by bidding or accepting potential leads when the current client list contains too few current clients. The information includes current status, such that the agent may remember the current goals and next steps for each client.

A lead management subsystem may direct the distribution of customers and monitor agent progress with the customers. In some cases, as above, the lead management subsystem will monitor reverse auctions. In other cases, as above, the lead management subsystem will monitor a quick match. However, the lead management subsystem may monitor other forms of customer acquisition including co-representation opportunities, leads and marketing responses.

In one embodiment, the lead management subsystem manages referral opportunities. Referral opportunities may come from people such as customers, clients or agents. After working within the web service system, agents may prefer to have the organization and tools provided within the web service system and therefore request their clients register for an account on the web service system. Other agents may not be familiar with or willing to represent a client and may therefore recommend the web service system. These referral opportunities may be tracked, and the number and frequency recorded, such that a frequent referring agent may be thanked and/or rewarded.

Once the referral opportunity has been given to the web service, the lead management subsystem may utilize an agent's match rating to inform the referrer of a good match, warn of a poor match or give recommendations based on the firm requested. Once informed, the customer or agent may then complete or abandon the referral. If completed, the system may then contact the selected agent and/or the customer to encourage the relationship to form and any terms and conditions to be accepted.

The match system may also be used to independently look up an agent that was recommended and give a match rating.

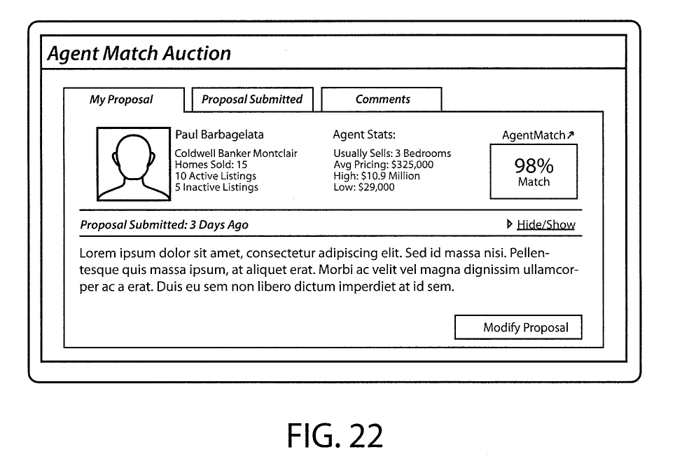

Turning now to FIG. 22, a screenshot of the auction proposal interface is shown. Once an agent has submitted a proposal, the proposal may be reviewed from this interface. The interface also contains other agent proposals for comparison. If the client or agents have specific questions or needs outside the bid, either party may make non-binding suggestions on the comments tab that may suggest important provisions that were not part of the original client submission.

While the previous discussion has centered on a customer searching for an agent, the match system may also be applied when a customer is searching for a house. Information contained in the search may be examined to create a request for a match from the information management subsystem. These agent match results may be shown in a sidebar along with the home results.

As used herein, the term “sidebar” refers to a location separated from primary content, including a location that may separate portions of primary content. For example, a sidebar may be located on the sides or top or bottom of a display area, or it may be located in between paragraphs of primary content. In the example above, the home search results may be the primary content and the agent match results may be the sidebar.

Search results may be examined in different ways to gather information to use in the request for a match. If the search uses home characteristics, those characteristics may be directly sent with the request for a match. If the request is for a neighborhood, the neighborhood may be examined for current characteristics and median or average values for the characteristics selected and sent with the request for a match. If the request is for a home, the home characteristics may be used or the broader scope of the neighborhood used and sent with the request for a match. Search history may also be used, where the results of the customer's search may be aggregated and used to determine the characteristics to be sent with the request to match.

These matches may then be used to pull relevant content from the agent information stored in the information management subsystem and display it to the user. Relevant information may include such things as agent profile photographs, home photographs, match rating, date the last home was sold, number of homes sold, average time on market and other statistics that may be tracked or derived from information in the information management subsystem. The click-through ratio may also be monitored such that the most relevant information for similar searches may be used.

The web service system may calculate areas of expertise for agents. An area of expertise is specific knowledge that may be attributed to an agent. The data in the information management subsystem may be used to calculate of such areas of expertise. Areas of expertise may include individual characteristics such as an individual area of expertise in a neighborhood, as evidenced by an agent's representation of numerous buyers or sellers in a neighborhood. Similarly, an agent may have an aggregate area of expertise in “First Time Homebuyers” which may be evidenced by individual areas of expertise in a price range, typical customer ages and FHA loans. These areas of expertise may be used to supplement information in the sidebar results related to searches or even appear on agent profiles.

Agent profiles may also benefit from match rating, areas of expertise and search results. When viewing a profile, the web service may review any searches performed by the customer and place them in a sidebar to the profile. The sidebar may then also include match ratings for the agent to the prior search results in the sidebar. Further, the search results may be examined by the web service and relevant areas of expertise may be placed on the agent's profile. For example, an agent who has subcharacteristics such as experience in a price range, typical customer ages and FHA loans may show the area of expertise in “First Time Homebuyers” to a customer who may be searching relevant houses to a “First Time Homebuyer.” However, to a customer that is not in the age nor price range, but has searched on terms relevant to FHA loans, the agent profile may display “FHA Experienced” in the place of “First Time Homebuyer.”

While shown in the context of a real estate transaction, it will be apparent to one of ordinary skill in the art that similar steps may be used for virtually any service provider with the calculation of for the service provider match being based on factors relevant for that industry and those sought by the customer.

While the present invention can be used specifically for searching and executing the method within a web-based service or in a system which is run on individual computers or private networks, etc., aspects of the present invention can also be used in the context of a search engine to improve searching for agents and in particular for generating improved search engine results pages (SERPS), etc. While discussed below as a web search system based process, it will be appreciated that it could be performed on intranets or other computer systems which are capable of receiving an relaying the needed information.

While a ranking algorithm and applications have been discussed above, the process may be further extended to encompass used in search engines. Indeed, the ranking algorithm may provide even more relevant results to search engines. In one embodiment, a profile server categorizes experience into areas of interest, such that a search engine may request matches to known areas of interest.

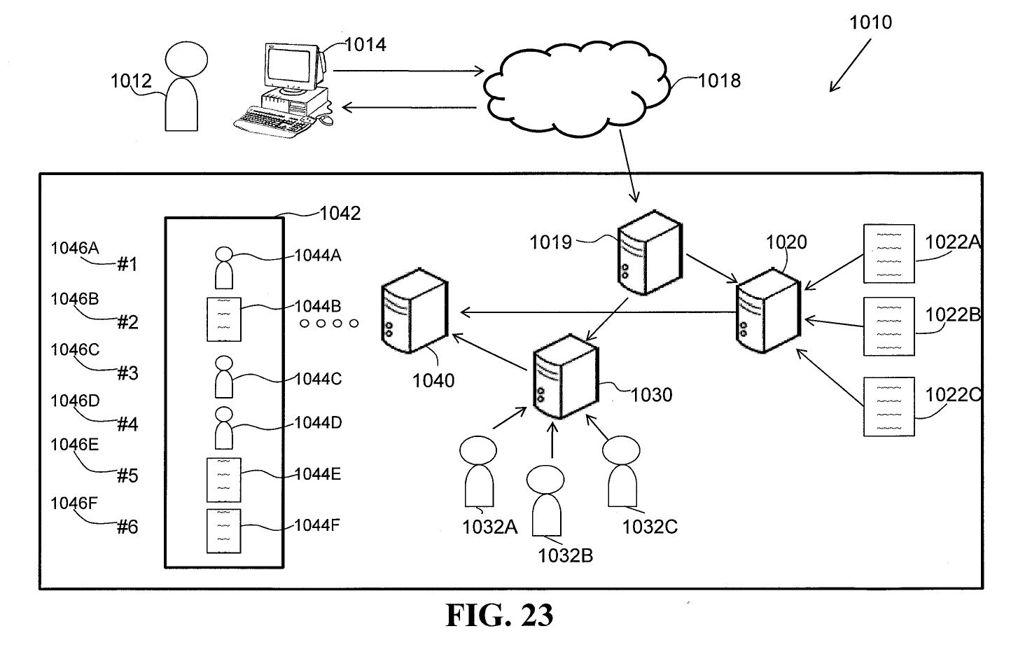

Turning now to FIG. 23, a diagram of internal interactions of a search system 1010 between an internet document server 1020, a professional profile server 1030 and a result server 1040. User 1012 through internet connected device 1014 submits a search request to web search system servers 1016 through the Internet 1018 and receives results 1042 of the search.

In one embodiment, the search request is captured by dispatch server 1019. Dispatch server 1019 may forward the request to internet document server 1020 and professional profile server 1030. In the case that dispatch server 1019 has been enhanced, dispatch server 1019 may detect whether the search is appropriate for internet document server 1020, professional profile server 1030 or both. Dispatch server 1019 with enhancements may then forward the search request to the appropriate servers.

Having received a request from dispatch server 1019, internet document server 1020 may gather and rank relevant internet documents 1022A, 1022B and 1022C based on the search request received. These documents and their associated ranking scores are then forwarded to result server 1040 for aggregation and sorting.

Professional profile server 1030 may also receive the search request from dispatch server 1019. Search terms within the search request may be examined for professional areas of expertise. Using the areas of expertise and any modifying terms within the search request, relevant professional profiles 1032A, 1032B and 1032C are gathered and ranked. The profiles and associated ranking scores are then forwarded to result server 1040 for aggregation and sorting.

Result server 1040 organizes results 1042 according to the rankings submitted for each result element 1044A, 1044B, 1044C, 1044D, 1044E and 1044F. The result server may then determine the final order 1046A, 1046B, 1046C, 1046D, 1046E and 1046F of the result elements. Results 1042 are then communicated to internet connected device 1014 and displayed to user 1012. In one embodiment, result server 1040 compiles the results into a web page and sends the web page to internet connected device 1014.

In some cases, there may be difficulty measuring the relevance of an internet document compared with a professional profile. Therefore, it may be useful to scale the rankings such that both sets of results may be combined. In one embodiment, the result server may normalize each result set such that each result set may have the same total result value, but individual results may vary. In another case, each server may normalize the result set to a maximum relevance value. When the sets are then combined, the result with the best relevance ranking will then be at the top of the search engine result page (SERP).

The SERP may be constructed on many different technologies. While SERP's are discussed as web pages for clarity, it should be recognized that many different technologies and communications may be used. For instance, the SERP may be constructed in or contained within HTML, XML, XHTML, RSS technologies, ATOM, AJAX, Document Object Model, email, text, PDF, SMS, push notification and other communications or documents that may hold the SERP result data.

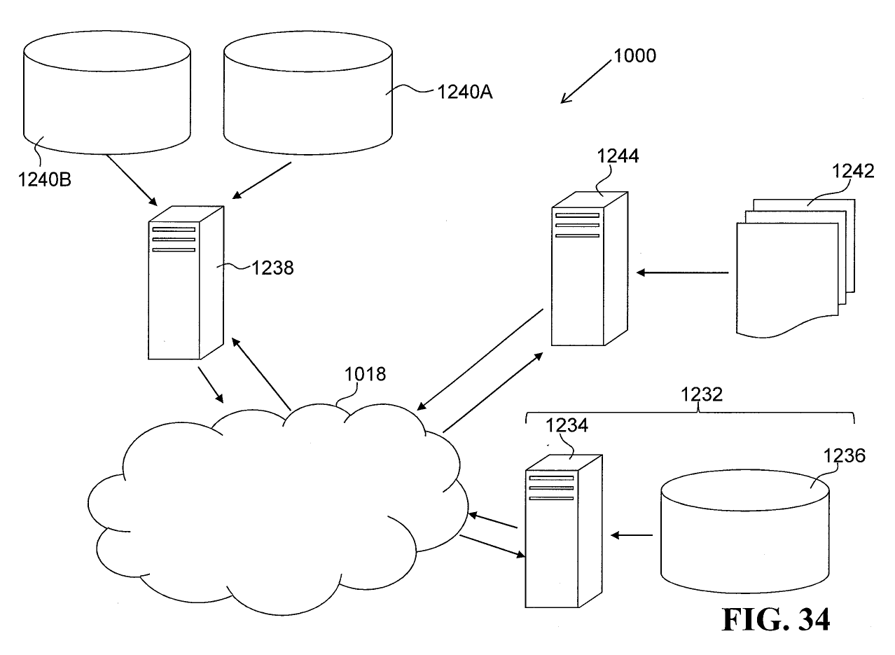

An information management subsystem (see FIG. 34 for more details) may keep the professional profile server data up to date. It may begin gathering when it discovers a new data source and adds a database for that source. Current data within the new database is mined such that it may associate current data with a professional's history and area of expertise in a professional database. Until a search for a professional is received, the information management subsystem may continue to monitor the data sources and mine any new data for association with a professional's database.

The information system may calculate areas of expertise for professionals. An area of expertise is specific knowledge that may be attributed to a professional. The data in the information management subsystem may be used to calculate such areas of expertise. Areas of expertise may include individual characteristics such as an individual area of expertise for a real estate agent in a neighborhood, as evidenced by an agent's representation of numerous buyers or sellers in a neighborhood. Similarly, a professional may have an aggregate area of expertise such as a real estate agent's area of expertise in “First Time Homebuyers” which may be evidenced by individual areas of expertise in a price range, typical customer ages and FHA loans. Another example of aggregate expertise for professionals is a medical doctor areas of expertise in cardiology or neurology.

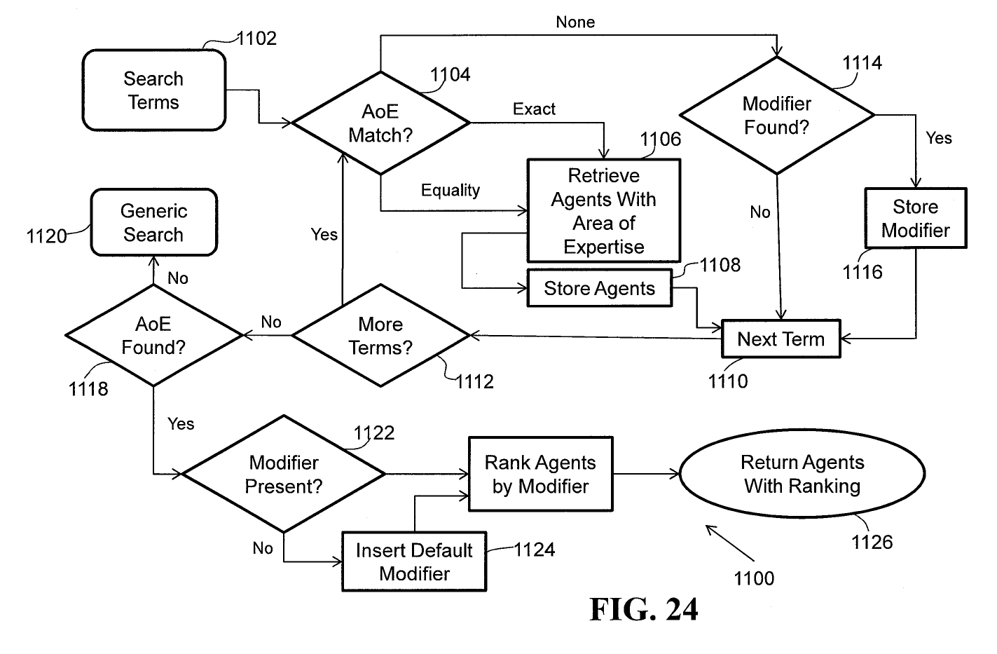

Turning now to FIG. 24, a flow chart of term-experience matching subsystem 100 is shown. While the subsystem process is shown for agent profiles for clarity reasons, it should be recognized that the process is similar for other professionals. It should also be recognized that search terms may be broken up into term units. Term units may be further broken down into other term units or combined to make new term units. Therefore the available number of term units may be greater than the number of original search terms, depending on the analysis algorithm.

The search terms 1102 are received by term-experience matching subsystem 1100 and broken down into smaller term units, if possible. Each term unit is examined to see if they match an area of expertise 1104. If the area of expertise is an exact match or found to be equivalent, the agent database retrieves agent profiles with the requested area of expertise 1106. The agent profile results are stored for later examination 1108. The next term unit is then requested 1110 if there are more term units 1112. If more term units are available, the matching process begins again at whether the term unit matches an area of expertise 1104.

If the term unit does not match an area of expertise 1104, the term unit will be examined for a modifier 1114. If the modifier is found, it will be stored for later use 1116. In either case, whether the modifier is found or not, the system will move to the next term 1110, if any are available 1112.

A modifier may represent a specific need related to an area of interest. Simple modifiers include “must,” “not,” and “never.” For instance, if a search requests an area of expertise “must” include farmland, agent profiles without farmland experience should be excluded. Modifiers may also include minimum, maximum, level of desire, level of importance or other ranges, cutoffs, or weights to include in the ranking algorithm. Modifiers may also be implicit in the term units because of order, punctuation, overall context, local context and expected default behavior.

Once the term units are exhausted 1112, the term-experience matching subsystem 1100 checks to make sure that at least one area of expertise was found 1118. If not, the term-experience matching subsystem 1100 returns a message signaling that there are no results 1120. In this case, the system suggests that a generic search should be performed.

If at least one area of expertise was found 1118, term-experience matching subsystem 1100 also checks for modifiers that may alter the ranking algorithm 1122. If no modifiers were found, then a default modifier for the ranking algorithm will be selected 1124. The agent profiles are then ranked 1126 and returned with their ranks 1126.

The ranking algorithm may result in a general relevance rating for use in comparison with other internet documents, or it may produce an intermediate ranking which may be scaled for relevance comparison with other internet documents.

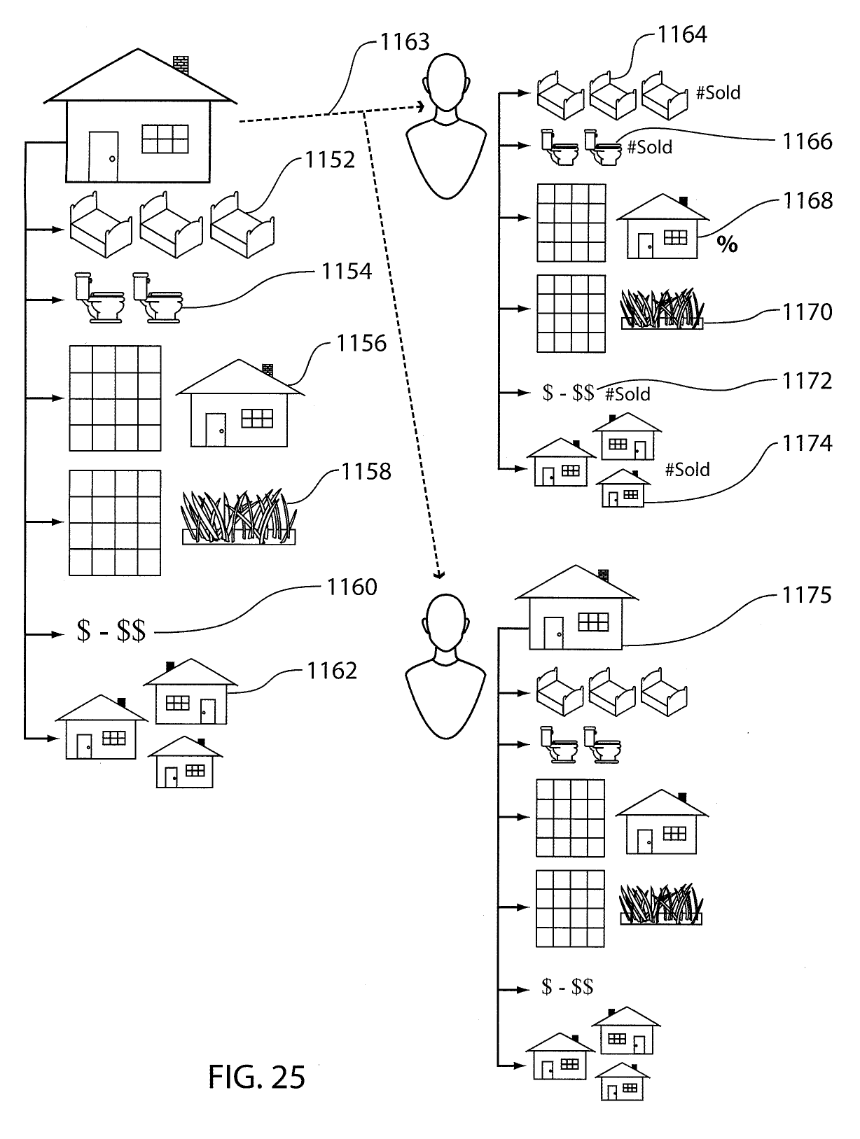

Turning now to FIG. 25, a diagram of professional experience to search term ranking subsystem 1130 is shown. While the subsystem process is shown for agent profiles for clarity reasons, it should be recognized that the process is similar for other professionals. A typical professional profile can include years of experience, number of lawsuits pending or resolved, negative or average user reviews, average fees, locations of service, number of clients serviced, office location, licenses/certificates active or inactive, education, and active insurances. In the context of an agent to home buyer/seller system, a professional experience to search term ranking subsystem 1130 is called a result matching system.

Using search terms, area of expertise data 1150 is extracted by term-experience matching subsystem 1100 that was entered by the user 1012 (not shown). Each extracted area of expertise 1152, 1154, 1156, 1158, 1160 and 1162 is compared with the stable of homes sold by the agent. The advantage of the matching system is that an agent's (or professional's) experience is matched to the home characteristics. An agent that normally sold million dollar homes may be inexperienced in selling starter homes because the needs, desires and trade-offs are different. Likewise, an agent well versed in selling single family homes, may have little experience with condominiums and the like. Thus, in accordance with the present invention, it is desirable to improve the match between the customer's (or client's) needs and the experience of the agent (or professional) who will be working with the customers.

In one embodiment, the number of bedrooms 1152, bathrooms 1154, square footage 1156, lot size 1158, price range 1160, and/or building type or neighborhood 1162 are compared 1163 against the number of homes sold by the agent with similar bedrooms 1164, bathrooms 1166, square footage 1168, lot size 1170, price range 1172 and/or number of homes/condominiums (etc.) sold at or near the neighborhood desired 1174. This is referred to herein as an agent experience match system (or more generically a professional experience match system).

In an alternate embodiment, each home purchased or sold by the agent 1175 is rated on the home data 1150 provided by the customer. Each agent home rating is then aggregated to form a match rating. This is referred to herein as an agent home match system (or more generically, a professional procedure/product match system).

Each of the agent home criteria may be weighted such that inexact matches contribute a partial rating, such as a two bathroom house contributing a partial rating to a desired one and one half bathroom house, because of the close proximity to the desired result. These rating weights may be based on a selected importance by the customer or pre-set by the result matching system.

Further, static data may also be included in the result matching system. For example, it has been noted that there is likely a correlation between response time to a customer request and a positive real estate outcome. Therefore, an agent may also be rated on his or her responsiveness to the customer. Other professionals may also be rated on responsiveness, such as contractors, doctors, and childcare.

These static data points may be pre-compiled and stored along with the agent's other static data, such as contact information. When the result matching system is requested by a customer, a portion of the agent rating may depend on such static data, but the rating overall is dynamic, based on the areas of expertise extracted.

In one embodiment, outcomes are monitored for agents and/or customers. For a seller, a larger than expected price (per square foot or other home characteristics), properties they have closed as seller or buyer, if a re-list occurred, property price fluctuations over time compared with the local, state and national markets and the amount of time on the market may be noted and stored as part of the agent's history with that sale. For a buyer's agent, similar statistics may be gathered and stored evidencing such characteristics as a lower than expected purchase price, quick closing or other desirable concessions. If no transaction is forthcoming, a failure may also be stored. Customer performance metrics may be monitored and scored as well. Negative reviews decrease match score, while positive reviews and frequent closing will increase match score. These data points may be internally or externally gathered. Thus, the particular success of the agent may be dependent on performance of each real estate deal.

In another embodiment, the agent's history or “track record” is overlaid on a baseline or “hyper-local comparable market average” to evaluate the effectiveness of a realtor. For example, the price per square foot of the properties in each transaction that a realtor represented is compared with the geographically immediate comparable sales price per square foot (in last 6 months). The sale price versus listing price (“spread”) is evaluated relative to the same population and days on market (“DOM”). The system also evaluates whether the agent represented the buy or sell side compared with the current home characteristics request. The results of the comparisons are then aggregated such that a value may be given to agent's history relative to the current home characteristics request.

For example, a buy side performance measure may compare a $212 price per square foot versus an average market of $289 per square foot and give a positive match rating of +40 points. A seven percent list versus sell spread compared with a four percent average may give a match rating of +10 points. These points are then aggregated in a total match rating for the agent compared with the house characteristics.

In another example, a sell side performance may compare 52 DOM versus an average of 92 DOM in the market and give +20 points match rating. A $252 price per square foot received versus a market average of $221 per square foot market average may give +50 points match rating. These points are then aggregated in a total match rating for the agent compared with the house characteristics. The same philosophy of comparing an agent's performance to the average in the real estate market can be used for all professions.

Similar data points can be used for a variety of other service providers. For example, a doctor may be analyze on the average cost of a surgery, average recuperation time, client mobility after the surgery, etc. Other service providers may be ranked on similar performance characteristics.

In one embodiment the match ratings are normalized such that the top match point value is given a rating of 99%. This communicates that the result matching system believes the professional to be the best professional for the job.

External data sources may be monitored and mined. These data sources may be from private or public bodies. The result matching system may connect to external systems such as Multiple Listing Services (MLS), doctor rating services or information brokerages. The result matching system may also connect to public data sources as well, including government sources, such as tax data, title data or even discipline data. These sources can then be used to in the matching algorithm. For instance, an professional that turns up disciplinary violations may rank lower than a similar professional without those violations.

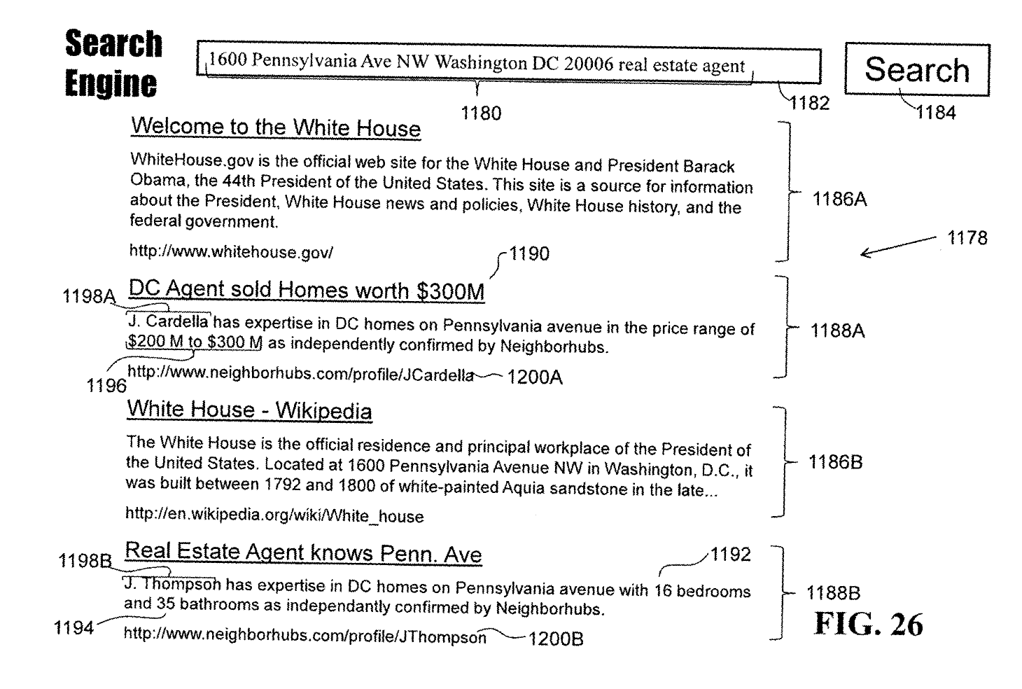

Turning now to FIG. 26, a search engine result page (SERP) 1178 with organic experienced professional results is shown. A user 1012 (not shown) may type in search terms 1180 within a search box 1182 and initiate a search such as a click on activate a search button 1184. Resulting SERP 1178 may be shown in response to such request.

In one embodiment, the SERP may contain both standard results 1186A and 1186B in combination with expertise results 1188A and 1188B. All of the results are organic, meaning non-paid SERP results. The advantage is that the user is presented with both classical ranking documents with expertise based profiles to present relevant results based on the search terms entered.

More specifically, the term-experience matching subsystem and the result matching system recognized that 1600 Pennsylvania Ave in Washington D.C. has specific spotlights of an “estimated value of $300 Million” 190, “16 bedrooms” 1192 and “35 bathrooms” 1194. The system may have been able to gather other facts that are implicit in the search such as the typical age of the residents of the neighborhood and family composition of the neighborhood residents. The result matching system may then compile and rank the agents according to their areas of expertise relative to the search terms. The SERP result for the agents may then contain descriptions relating to which area or areas of expertise were significant in their rating for the search terms. In this embodiment, the result matching system decided that J. Cardella's price range 1196 was significant, while J. Thompson's experience in similar number of bedrooms and bathrooms were significant.

Having decided that the results were significant, the system then combines the expertise results 1188A and 1188B with standard results 1186A and 1186B. The result ordering is based off an overall relevance rating that compares a normalized expertise rating with classical result ratings. The expertise results use the professional profile information to compose expertise results 1188A and 1188B to appear as classical results 1186A and 1186B in the SERP. In one embodiment, it pulls the professional name 1198A and 1198B and professional profile link 1200A and 1200B. Because the SERP looks the same, the users are already familiar with its functionality, but are now given additional relevant results that may be more relevant than before.

These areas of expertise spotlights in 1190, 1192, 1194 and 1196 are beneficial because they increase the relevance and confidence of the user in the relevance of the results. For instance, a user may be looking at a specific property for a number of different reasons. A user looking at a price range may be attracted to price range spotlight 1196. Another user may care about bedrooms and view bedroom spotlight 1192 as more relevant. Thus, in either case, the user is given information that may direct her to the desired information.

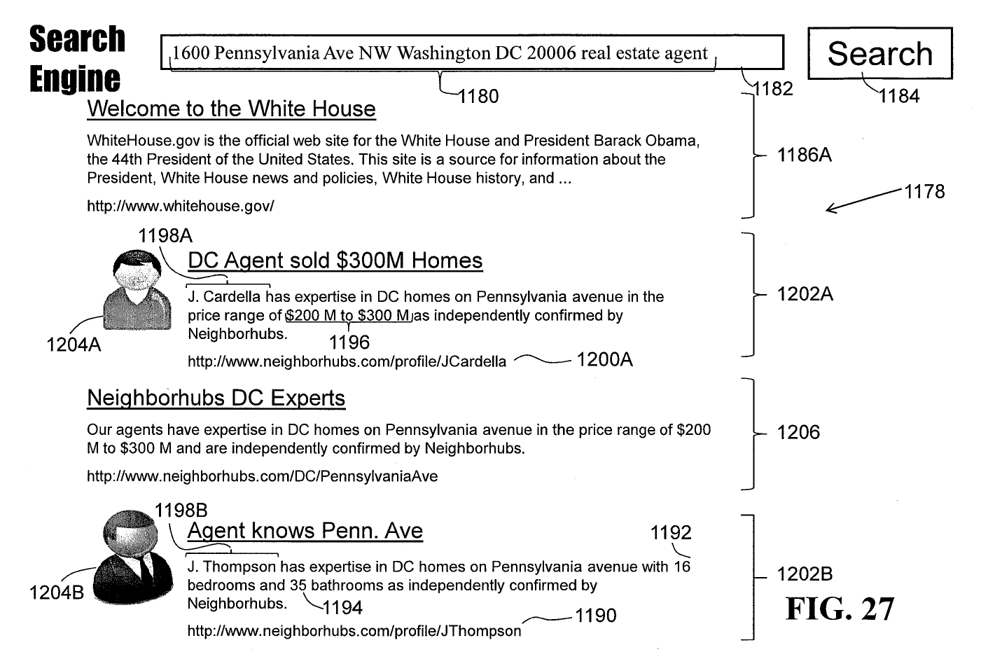

Turning now to FIG. 27, a search engine result page 178 with profile enhanced organic experienced professional results 1202A and 1202B is shown. Expertise results may be further enhanced or differentiated from classical results by the addition of profile information. This profile information may include profile pictures 1204A and 1204B, certifications, areas of expertise, related areas to consider and other information available in the profile data. The profile information may stem from single data entries such as a profile link or be combinations of data entries such as an average house price or area of expertise.

The enhanced organic experienced professional results 1202A and 1202B may be enhanced with the same or similar information, or further differentiated by selecting to display different profile information. In one embodiment, the enhanced organic experienced professional results 1202A and 1202B are enhanced with similar information to have a consistent user experience and allow for direct comparison. In another embodiment, the enhanced organic experienced professional results 1202A and 1202B vary the information presented such that a user who may not find one result relevant may find relevant information in another result. For example, one person may not find the price range spotlight 1196 relevant (or of higher importance), but may find the bedroom spotlight 1192 and bathroom spotlight 1194 relevant (or of higher importance).

Having expertise results does not mean that portions of the professional profile website will not receive classical result ranking. In fact, profile aggregation page 1206 may rank high in a classical ranking algorithm because it contains relevant information related to the search terms.

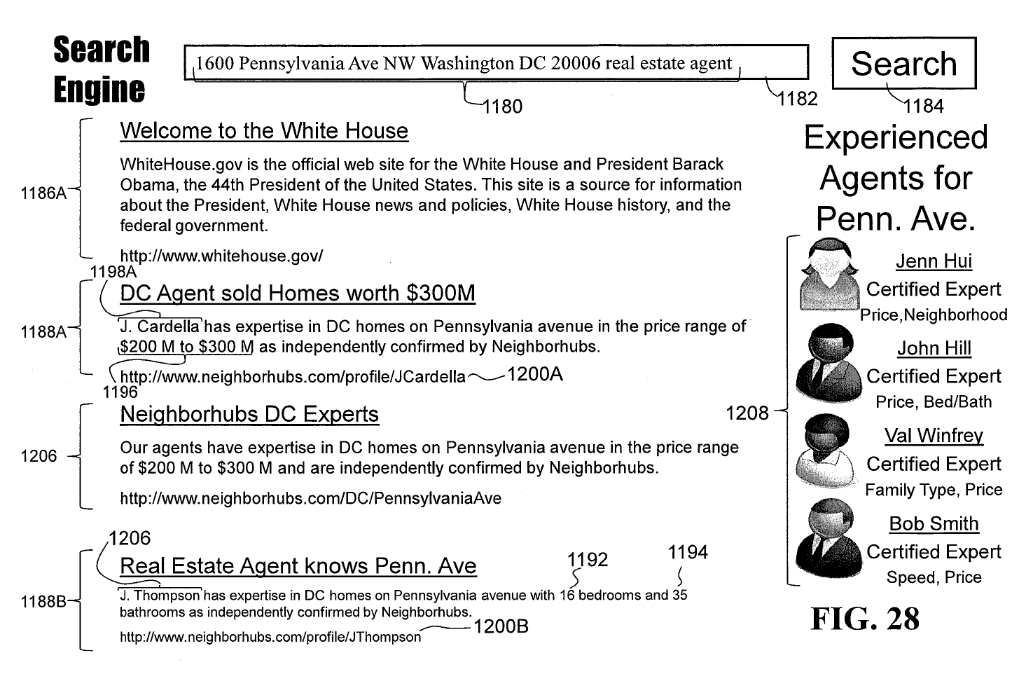

Turning now to FIG. 28, a search engine result page with organic experienced professional results and advertising that includes relevant certifications is shown. In addition to the organic results seen by 1186A, 1202A, 1206 and 1202B, search system 1010 (not shown) may also include a sidebar 1208. The sidebar 1208 may include advertising or further information for the user to consider.

As used herein, the term “sidebar” refers to a location separated from primary content, including a location that may separate portions of primary content. For example, a sidebar may be located on the sides or top or bottom of a display area, or it may be located in between paragraphs of primary content. In the example above, the organic search results may be the primary content and the agent match results may be the sidebar.

The search system 1010 may show a sidebar 1208 populated with professional listings 1210A, 1210B, 1210C and 1210D. Professional listings 1210A, 1210B, 1210C and 1210D may be ranked or displayed based on factors that may include their relevance to the search terms. The listings may include profile information, including names of professionals 1212A, 1212B, 1212C and 1212D. The profile may further be enhanced by certifications, which may include certifications of areas of expertise 1214A, 1214B, 1214C and 1214D by the professional experience matching subsystem or information management subsystem.

The certifications may be from individual certifications or aggregate certifications. For example, an agent who has certifications such as experience in a price range, typical customer ages and FHA loans may show the aggregate certification in “First Time Homebuyers” to a customer who may be searching relevant houses to a “First Time Homebuyer.” However, to a customer that is not in the age nor price range, but has search on terms relevant to FHA loans, the agent profile may display the individual certification of “FHA Experienced” in the place of “First Time Homebuyer.”

Professional listings 1210A, 1210B, 1210C and 1210D may be selected for display in the sidebar based on a separate ranking system for the organic results. In one embodiment, the sidebar 1208 comprises paid advertisements. The payment and relevance may then be used to decide if the professional listings 1210A, 1210B, 1210C and 1210D will show in the sidebar 1208.

In another embodiment, the professional listings 1210A, 1210B, 1210C and 1210D are supplemental results that are selected for sidebar display. These results may or may not have been included in the organic results. These results may include a diverse selection of certifications or other information presented by the professional experience matching subsystem.

In fact, the sidebar may be used in cases where the search engine does not include professional results within the organic results because the results did not rank high enough or the search engine has not included professional results within the organic results. The sidebar may therefore add useful information to current search engines, without much change to their current system.

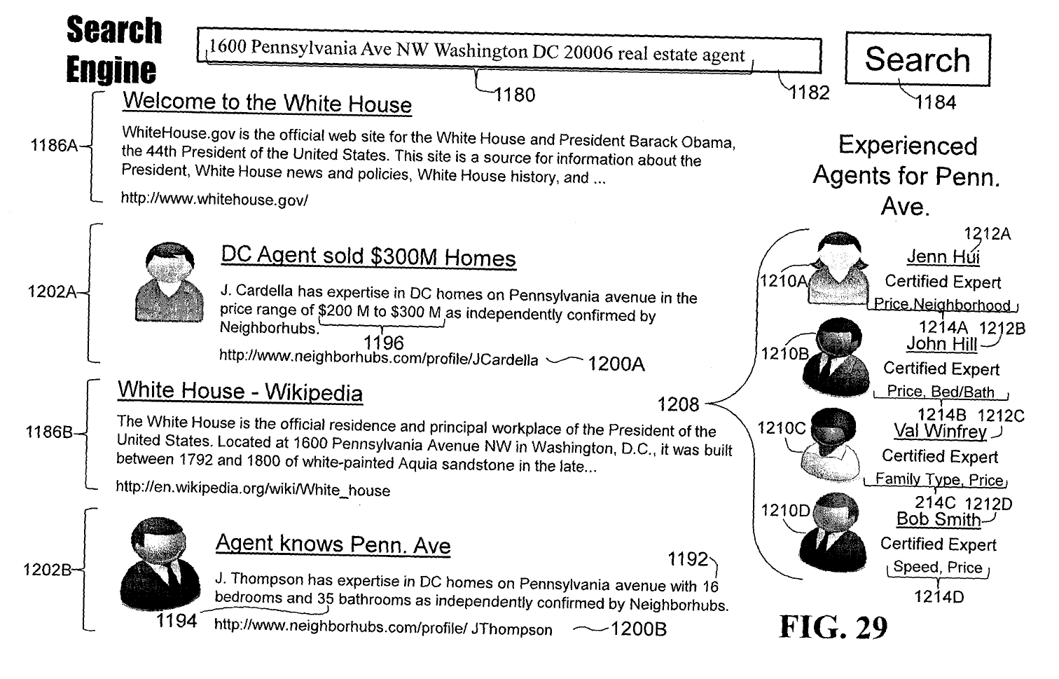

Turning now to FIG. 29, a search engine result page with profile enhanced organic experienced professional results and advertising that includes relevant certifications. In one embodiment enhanced organic experienced professional results 1202A and 1202B are used in conjunction with the sidebar 1208.

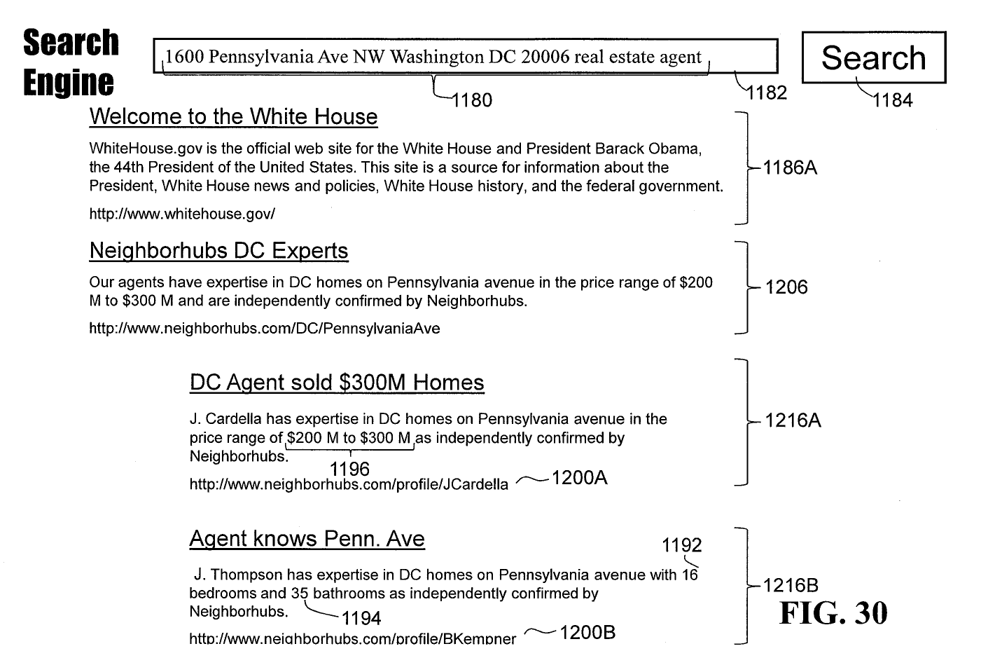

Turning now to FIG. 30, a search engine result page with professional results as supplemental to the organic result for the domain is shown. Instead of being shown as their own result, professional result 1216A and 1216B may be shown as supplements to the organic result of a classically ranked page such as profile aggregation page 1206. These supplemental results preserve the classical ranking algorithm of the search engine because they attach to the rank of their parent result, but provide useful results to the user based on their search terms.

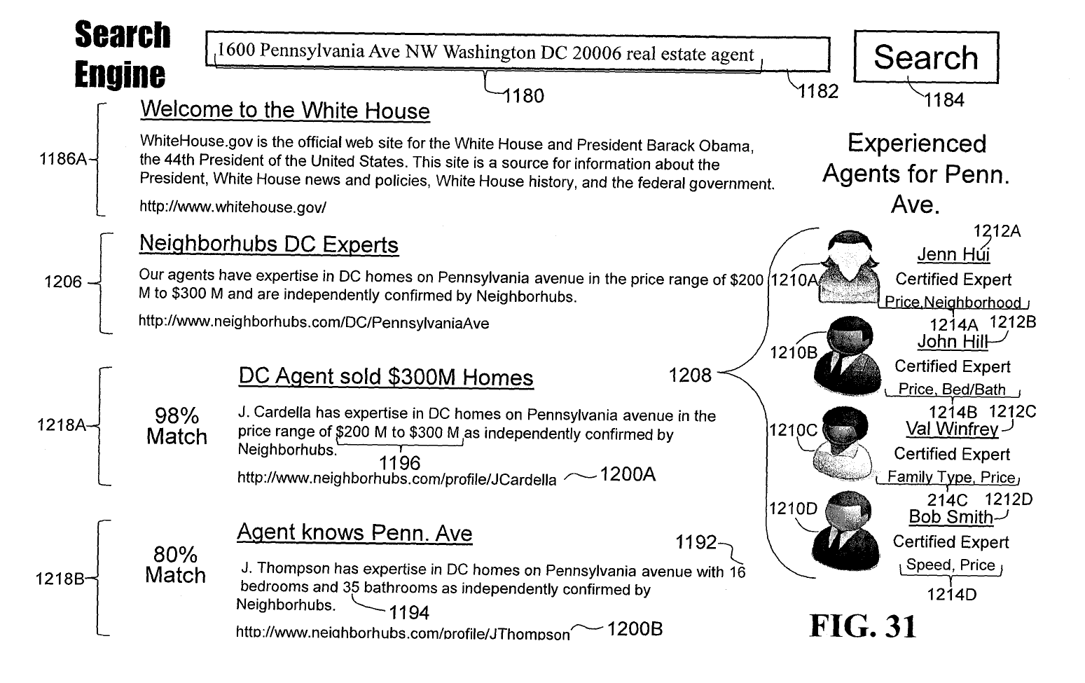

Turning now to FIG. 31, a search engine result page with profile enhanced professional results as supplemental to the organic result for the domain with advertising that includes relevant certifications is shown. The system may combine enhanced supplemental professional listings 1218A and 1218B with a sidebar 1208 and other features previously discussed.

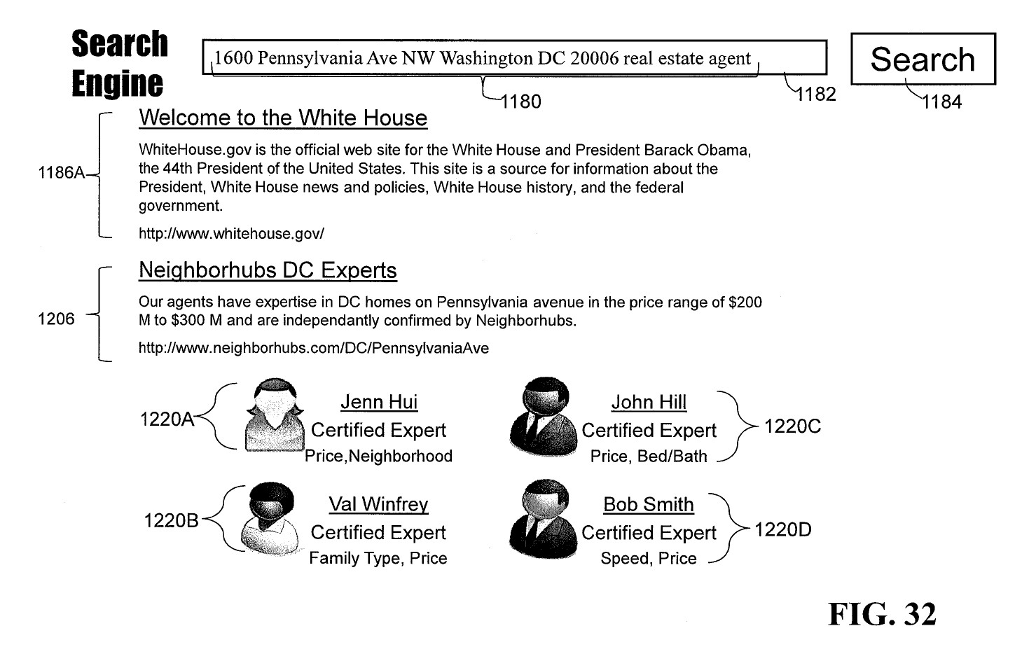

Turning now to FIG. 32, a search engine result page with certified professional results as supplemental to the organic result for the domain is shown. Supplemental results may have different formats, which may include information available from the profile data or information subsystem. These formats may be altered to suit the search engine style. In one embodiment, the supplement results may be supplemental certified results 1220A, 1220B, 1220C and 1220D which include profile pictures, names and links to the profile pages.

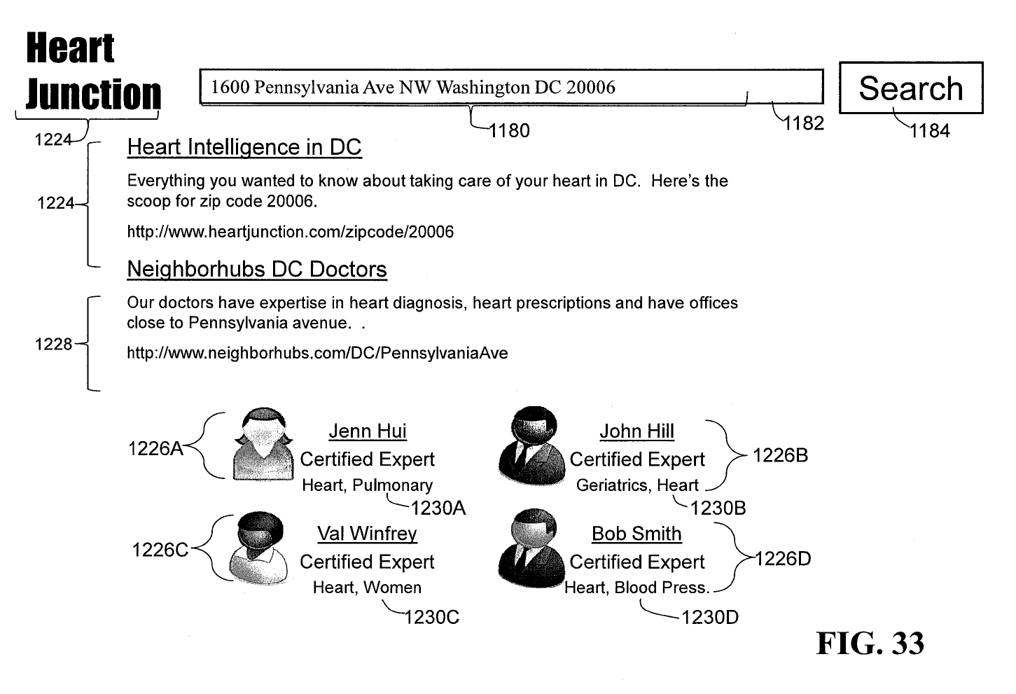

Turning now to FIG. 33, a website search with certified professional results related to the search and website. Searches may also be based on contextual information. In one embodiment, a user performs a search on a heart health website 1222. In addition to classical results 1224, the system may use the contextual information to return certified professional results 1226A, 1226B, 1226C and 1226D relating to the context of the website. In one embodiment, these results are placed under an organic listing for the professional rating service result 1228. The results may contain certifications 1230A, 1230B, 1230C and 1230D relating to the context of the website.

The context may be predetermined from an aggregate search of the website or from a view of the current search page. In one embodiment, the search code is sent information about the website to give the search engine context. The information may be contained in an invisible box in the search form or even part of a javascript code.

Turning now to FIG. 34, a diagram of data collection server and its connection to other content servers is shown. Search system 10 may comprise an information management subsystem 1232 with a data collection server 1234 connected to information storage 1236. The data collection server may query database server 1238 to collect information from its various databases 1240A and 1240B. The data collection server may also request documents 1242 from document server 1244. The requests and transmissions may be serviced by a network including the internet 1018.

The documents 1242 and databases 1240A and 1240B may be public or private, paid or unpaid information. By aggregating the data, information management subsystem 1232 may provide professional data and statistics for the rating of professionals.

While a significant focus of the discussion has been on residential real-estate for clarity, it should be appreciated that the system may be applied professionals generally, including commercial real estate, doctors, attorneys, financial consultants, manufacturing and other services or products. While specific data fields may be different, the desired fields may be compared against the professional's past transaction fields to prepare a valuation of that professional. Typical fields that can be relevant to call professional include years of experience, number of lawsuits pending or resolved, negative or average user reviews, average fees, locations of service, number of clients serviced, office location, licenses/certifications active or inactive, education, and active insurances.

While multiple servers and subsystems have been mentioned, it should be understood that the servers and subsystems may reside on a single machine or a single server or subsystem may span multiple machines. There is thus disclosed an improved system for matching property characteristics for matching characteristics about a desired procedure to professionals' or service providers' experience with performing like procedures or services. By correlating the experience of the professional or service provider with the characteristics of the procedure needed to be performed, a customer can obtain a better confidence level that the professional or service provider has relevant positive experience with similar procedures and is therefore more likely to perform the procedure or service to the satisfaction of the customer. While various professions and services and their relevant characteristics have been discussed, it will be appreciated that the system can be used with nearly any procedure or service to improve connecting between customers and those being sought to perform the procedure. The appended claims are intended to cover such methods. Additionally, it will be appreciated that numerous changes may be made to the present invention without departing from the scope of the claims.

What is claimed is:

1. A professional matching system comprising:
an information management module executing on one or more servers and configured for gathering and storing information regarding a plurality of professionals' and their procedural outcomes, and further configured to dynamically calculate a match rating of the plurality of professionals based on submitted procedure characteristics; and
a client module executing on one or more servers and configured for receiving submitted procedure characteristics from a client, further configured to receive one or more professional match results from the information management module, and further configured to deliver the results to a client computer.

2. The professional matching system of claim 1, wherein the information management module comprises a database having stored information regarding the plurality of professionals' outcomes, wherein the information includes information as to multiple characteristics of procedures performed by each professional.

3. The professional matching system of claim 2, wherein the stored information includes a comparison of the actual price to an expected price for each procedure performed by each of the plurality of professionals.

4. A method of matching professionals and clients comprising:
providing a web service system for communication with remote interfaces, the system comprising at least one server;
compiling a history of a plurality of professionals based procedure characteristics for each of a plurality of outcomes for the plurality of professionals;
comparing each procedure characteristic with a corresponding characteristic from each of the plurality of professionals' outcomes;
assigning a value to the result of the comparing step;
compiling an overall match value from the values from the assigning step for each of the plurality of professionals; and
communicating over the web service system one or more one or more professionals whose overall match value most closely corresponds with the procedure characteristics relevant to a client.

5. The method according to claim 4, wherein the procedure characteristics comprises expected price of the procedure.

6. The method according to claim 4, wherein the overall match value is computed by aggregating individual procedure characteristics into subvalues and then aggregating the subvalues into the overall match rating.

7. The method according to claim 7, wherein each of the procedures is assigned a value dependent on the correlation of the desired procedure characteristics and then aggregating the overall value by combining the value of each procedure.

8. A search system comprising:
an information management subsystem executing on one or more servers and configured for gathering and storing information regarding a plurality of professional results, and further configured to associate the plurality of professional results with a plurality of professional profiles;
a term-experience matching subsystem executing on one or more servers and configured to break the search terms into term units and match term units to areas of expertise; and
a professional profile server configured to match the areas of expertise to relevant professional profiles from the plurality of professional profiles and rank the relevant professional profiles using data from the information management subsystem.

9. The search system of claim 8, further comprising:
a classical results server configured to return classical results;
a results server configured to rank the classical results and professional profiles together and return a search engine result page.

10. A method of matching search terms to experienced professionals:
compiling a history of a plurality of professional experience characteristics for each of a plurality of results for a plurality of professionals;
receiving a set of search terms;
compiling a set of areas of expertise from the search terms;
compiling a set of experienced professionals relevant to the areas of expertise based at least in part on the plurality of results; and
ranking the set of experienced professionals according to the areas of expertise; and presenting the results.

11. The method according to claim 10, wherein the search terms include contextual information.

12. The method according to claim 10, wherein the ranking further comprises weighting the ranking by a modifier discovered in the search terms.

13. A professional experience matching system comprising:
an information management subsystem executing on one or more servers and configured for gathering and storing information regarding a plurality of results of service of a plurality of professionals, and further configured to calculate one or more areas of expertise for the plurality of professionals; and
a term-experience matching subsystem executing on one or more servers and configured to break the search terms into term units and match term units to areas of expertise.

14. A search engine result page displayed on a screen associated with a processor comprising:
a set of search terms;
a set of classical results related to the search terms; and
a set of professional results related to the search terms.

15. The search engine result page of claim 14, wherein the set of search terms further comprises areas of expertise.

16. The search engine result page of claim 15, wherein the professional results comprise information from professional profiles.

17. The search engine result page of claim 16, wherein the professional profiles contain the at least one of the areas of expertise.

18. A method for matching a service provider to a customer needing a service performed, the method comprising:
compiling a plurality of statistics relevant to a service to be performed in a database;
creating a plurality of service provider profiles in a database;
associating at least some of the statistics with at least one service provider profile;
receiving a search request that includes service characteristics;
comparing the service characteristics to at least one of the plurality of the statistics in the service provider profiles; and
identifying service providers to most closely match the desired statistics.

19. The method according to claim 18, wherein the method comprises:
aggregating the rating values of the statistics with one of the service provider profiles and computing a profile ranking based on aggregated ranking values; and
returning at least one of the service providers with a corresponding profile ranking.

20. The method according to claim 19, wherein the service provider is a doctor;

21. The method according to claim 19, wherein the service provider is a lawyer;

22. The method according to claim 19, wherein the service provider is a plumber;

23. The method according to claim 19, wherein the service provider is a contractor;

24. The method according to claim 19, wherein the service provider is an accountant.

25. A search system comprising:
an information management subsystem executing on one or more servers and configured for gathering and storing information regarding a plurality of service provider results, and further configured to associate the plurality of service provider results with a plurality of service provider profiles;
a term-experience matching subsystem executing on one or more servers and configured to break the search terms into term units and match term units to areas of expertise; and
a service provider profile server configured to match the areas of expertise to relevant service provider profiles from the plurality of service provider profiles and rank the relevant service provider profiles using data from the information management subsystem.

26. The search system of claim 25, further comprising:
a classical results server configured to return classical results; and
a results server configured to rank the classical results and service provider profiles together and return a search engine result page.

27. A method of matching search terms to experienced professionals comprising:
compiling a history of a plurality of professional experience characteristics for each of a plurality of procedure results in a database;
receiving a set of search terms;
compiling a set of areas of expertise from the search terms;
compiling a set of experienced professionals relevant to the procedures based at least in part on the plurality of procedure results; and
ranking the set of experienced professionals according to the areas of expertise; and presenting the results for the plurality of procedures.

28. The method according to claim 27, wherein the search terms include contextual information.

29. The method according to claim 27, wherein the ranking further comprises weighting the ranking by any modifiers discovered in the search terms.

30. A service provider experience matching system comprising:
an information management subsystem executing on one or more servers and configured for gathering and storing information regarding a plurality of results of service of a plurality of service providers and further configured to calculate one or more areas of expertise for the plurality of service providers; and
a term-experience matching subsystem executing on one or more servers and configured to break the search terms into term units and match term units to areas of expertise.

31. A service provider experience matching system comprising:
a database having a plurality of statistics regarding a procedure;
a database of a plurality of service provider profiles, the profiles associated with one or more of the statistics regarding the procedure;
a search server providing a search interface to receive search information and output procedure characteristics; and
a matching server receiving the procedure characteristics, matching the procedure characteristics to the statistics regarding the procedure and outputting a set of profiles, the set of profiles comprising the plurality of service providers having statistics associated with the procedure.

32. The system of claim 31, wherein the statistics comprises statistics about medical procedures performed by a doctor.

33. The system of claim 31, wherein the statistics comprises statistics about cases handled by an attorney.

34. The system of claim 31, wherein the statistics comprises statistics about buildings built by a contractor.

35. The system of claim 31, wherein the statistics comprises statistics about services performed by an accountant.

36. The system of claim 31, wherein the statistics comprises statistics about closings handled by a real estate agent.

37. A method for selecting a service provider comprising:
selecting a database having a plurality of service provider profiles including experience of the service provider with a procedure;
imputing a plurality of procedure characteristics; and
generating a list of service providers based on the relevance of the service provider profiles to the procedure characteristics.

38. The method of claim 37, wherein the method further comprises allowing a customer to select which service provider on the list he or she wishes to receive bids from.

39. The method of claim 38, wherein the method further comprises notifying the service providers who are selected of their opportunity to bid on performing the procedure for the customer.

40. The method of claim 37, wherein the real estate agents on the list are provided with a score based on relevancy to the property characteristics entered.

41. The method of claim 37, wherein the method comprises pairing a customer with a service provider on the list and monitoring the outcome of the procedure and adjusting the rating of the service provider based on the outcome.

42. The method according to claim 37, wherein the method comprises paying a customer upon the completion of a procedure handled by a service provider selected from the list of service providers.
